(19) United States
(12) Patent Application Publication
(10) Pub. No.: US 2016/0304782 A1
(43) Pub. Date: Oct. 20, 2016

(54) LIQUID CRYSTAL DISPLAY ELEMENT AND METHOD FOR PRODUCING SAME

(71) Applicant: DIC CORPORATION, Tokyo (JP)

(72) Inventors: Shinji OGAWA, Kita-adachi-gun (JP); Yoshinori IWASHITA, Kita-adachi-gun (JP); Takeshi KURIYAMA, Kita-adachi-gun (JP); Shinichi HIRATA, Kita-adachi-gun (JP)

(73) Assignee: DIC Corporation, Tokyo (JP)

(21) Appl. No.: 15/102,144

(22) PCT Filed: Dec. 4, 2014
(86) PCT No.: PCT/JP2014/082112

§ 371 Date: Jun. 6, 2016

(30) Foreign Application Priority Data
Dec. 11, 2013 (JP) 2013-255979

(51) Int. Cl. C09K 19/30; G02F 1/1341; G02F 1/1337; G02F 1/1335; C09K 19/56; C09K 19/54

(52) U.S. Cl. CPC C09K 19/3003; C09K 19/56; C09K 19/542; G02F 1/133723; G02F 1/133514; G02F 1/133707; G02F 1/1341; G02F 1/133788; C09K 2019/3004; C09K 2019/3009; C09K 2019/301; C09K 2019/3016; C09K 2019/548; G02F 2001/133742; G02F 2001/13415; G02F 2201/121; G02F 2201/123; G02F 2201/124

(57) ABSTRACT

There is provided a liquid crystal display element that suppresses occurrence of drop marks in production without degrading various properties of the liquid crystal display element, such as dielectric anisotropy, a viscosity, a nematic phase upper limit temperature, and a rotational viscosity (γ₁), and ghosting property of the liquid crystal display element and a method for producing the same. In addition, it is possible to produce a liquid crystal display element that has excellent high-speed responsiveness of the liquid crystal display element, stable alignment properties and pre-tilt angles of liquid crystal molecules, and in which ghosting is less likely to occur and drop marks are less likely to occur in the production of the liquid crystal display element. The liquid crystal display element can be effectively used as a display element for liquid crystal TVs, monitors, and the like.

### TECHNICAL FIELD

The present invention relates to a liquid crystal display element useful as a constituent member of a liquid crystal TV or the like and a method for producing the same.

### BACKGROUND ART

Liquid crystal display elements have been used for various measuring instruments, panels for automobiles, word processors, electronic organizers, printers, computers, televisions, clocks, advertising boards, and the like, including watches and calculators. Typical examples of a liquid crystal display mode include a twisted nematic (TN) mode, a super twisted nematic (STN) mode, a vertical alignment (VA) mode that uses a thin film transistor (TFT), and an in-plane switching (IPS) mode. Liquid crystal compositions used for such liquid crystal display elements need to be stable against external factors such as moisture, air, heat, and light, exhibit a liquid crystal phase in a temperature range as wide as possible about room temperature, and have a low viscosity and a low drive voltage. Further, a liquid crystal composition contains several to several tens of compounds for the purpose of achieving, for example, an optimum dielectric anisotropy (Δ∈) and an optimum refractive index anisotropy (Δn) with respect to individual liquid crystal display elements.

In VA-mode displays, a liquid crystal composition whose Δ∈ is negative is used, and is widely used for a liquid crystal TV or the like. On the other hand, low-voltage driving, high-speed response, and a wide operation temperature range have been required for all driving types. That is, Δ∈ with a high absolute value, a low viscosity (η), and a high nematic phase-isotropic liquid phase transition temperature (Tₙᵢ) have been demanded. Further, to set Δn×d, which is a product of Δn and a cell gap (d), Δn of the liquid crystal composition needs to be adjusted in an appropriate range in accordance with the cell gap. In addition, since an importance is given to high-speed responsiveness when liquid crystal display elements are applied to televisions or the like, a liquid crystal composition having a low rotational viscosity (γ₁) is demanded.

On the other hand, use leads to wide use of a multi-domain vertical alignment (MVA) mode liquid crystal display element in which in order to improve the viewing angle characteristic of a VA-mode display, the alignment direction of liquid crystal molecules in a pixel is divided into plural directions by providing a projecting structure on a substrate. The MVA-mode liquid crystal display element has excellent viewing angle characteristics but has a problem in which the vicinity of the projecting structure and a portion far from the projecting structure on the substrate have different response speeds of liquid crystal molecules and the response speed as a whole is not sufficient due to the influence of liquid crystal molecules at a low response speed in the portion far from the projecting structure, thereby causing the problem of degrading transmittance due to the projecting structure. In order to resolve the problem, a polymer sustained alignment (PSA) liquid crystal display element (including a polymer stabilized (PS) liquid crystal display element) is developed as a method for providing a uniform pre-tilt angle in a divided pixel without providing a non-transmissive projecting structure in a cell unlike in a general MVA-mode liquid crystal display element. The PSA liquid crystal display element is produced by adding a small amount of reactive monomer to a liquid crystal composition, introducing the liquid crystal composition into a liquid crystal cell, and then polymerizing the reactive monomer in the liquid crystal composition by irradiation with an active energy ray while applying a voltage between electrodes. Therefore, a proper pre-tilt angle can be provided to the divided pixel, and as a result, contrast can be improved due to improvement in transmittance and high-speed responsiveness can be achieved by providing a uniform pre-tilt angle (for example, see Patent Literature 1). However, in the PSA liquid crystal display element, the reactive monomer needs to be added to the liquid crystal composition and this has caused many problems in an active matrix liquid crystal display element requiring a high voltage retention rate. There is another problem in that display failure such as ghosting occurs.

As a method with which the drawbacks of the PSA liquid crystal display element can be overcome and a uniform pre-tilt angle is provided to liquid crystal molecules without contamination by foreign matters other than liquid crystal materials in the liquid crystal composition, a method has been developed in which a reactive monomer is mixed into an alignment film material, a liquid crystal composition is introduced into a liquid crystal cell, and the reactive monomer in the alignment film is polymerized by irradiation with an active energy ray while applying a voltage between electrodes (for example, see Patent Literatures 2, 3, and 4).

Meanwhile, as the size of the screen of liquid crystal display elements becomes larger, a method for producing a liquid crystal display element has undergone significant changes. That is, since a vacuum injection method of the related art requires a long time for producing processes when large-size panels are produced, a one-drop-fill (ODF) type producing method has become the mainstream technology for producing large-size panels (for example, see Patent Literature 5). Since this method can shorten the injection time as compared to the vacuum injection method, it has become the mainstream method for producing a liquid crystal display element. However, a phenomenon that drop marks formed by dropping the liquid crystal composition remain in the liquid crystal display element while retaining their shapes even after production of the liquid crystal display element, is a new problem. Incidentally, the drop marks are defined as a phenomenon that the trace left by dropping the liquid crystal composition appears as white marks in black display. In particular, in the aforementioned method in which a reactive monomer is added to an alignment film material so as to provide a pre-tilt angle to liquid crystal molecules, the reactive monomer that is a foreign matter is present in the alignment film when the liquid crystal composition is dropped on the substrate, and thus the problem of drop marks easily occurs. Further, in general, the occurrence of drop marks frequently depends on the choice of the liquid crystal material and the exact cause thereof is not clear.

As a method for suppressing drop marks, a method has been disclosed in which a polymerizable compound mixed into a liquid crystal composition is polymerized to form a polymer layer in a liquid crystal composition layer, thereby suppressing the occurrence of drop marks in relation to an alignment control film (for example, see Patent Literature 6). However, similarly to the PSA method and the like, this method has a problem in that ghosting occurs due to the reactive monomer added to the liquid crystal composition and that the effect of suppressing drop marks is not sufficient. Thus, development of a liquid crystal display element with which ghosting and drop marks are less likely to occur while maintaining basic characteristics needed for liquid crystal display elements has been demanded.

### CITATION LIST

### Patent Literature

Patent Literature 1: JP 2002-357830 A
Patent Literature 2: JP 2010-107536 A
Patent Literature 3: US 2011/261295 A
Patent Literature 4: JP 2011-227284 A
Patent Literature 5: JP 6-235925 A
Patent Literature 6: JP 2006-58755 A

### SUMMARY OF INVENTION

### Technical Problem

The present invention has been made under the above-described circumstances, and an object thereof is to provide a liquid crystal display element that suppresses occurrence of drop marks in production without degrading various properties of the liquid crystal display element, such as dielectric anisotropy, a viscosity, a nematic phase upper limit temperature, and a rotational viscosity (γ₁), and alignment stability or ghosting property of the liquid crystal display element, and a method for producing the liquid crystal display element.

### Solution to Problem

In order to solve the above-described problems, the present inventors have investigated on various combinations of methods for providing pre-tilt angles in liquid crystal display elements, and they found that the above-described problems can be solved by a method in which a reactive polymerizable compound is allowed to be contained in a vertical alignment film, a liquid crystal composition containing a polymerizable compound is introduced into a liquid crystal cell, and then the reactive polymerizable compound in the alignment film and the polymerizable compound contained in the liquid crystal composition are polymerized by irradiation with an active energy ray while applying a voltage between electrodes. Thus, the invention of the present application has been completed.

That is, according to the present invention, there is provided a liquid crystal display element including: a first substrate having a common electrode; a second substrate having a pixel electrode; and a liquid crystal composition layer interposed between the first substrate and the second substrate, the liquid crystal display element controlling liquid crystal molecules in the liquid crystal composition layer by applying an electrical charge between the common electrode and the pixel electrode substantially vertically to the first substrate and the second substrate, wherein

a vertical alignment film that controls an alignment direction of the liquid crystal molecules in the liquid crystal composition layer substantially vertical to surfaces of the first substrate and the second substrate that are adjacent to the liquid crystal composition layer is provided on at least one of the first substrate and the second substrate, the vertical alignment film contains a polymerizable compound having a reactive group or a polymer of a mixed product thereof, and a polymer of one or two or more kinds of polymerizable compound which controls the alignment of the liquid crystal molecules to stabilize the alignment is formed on the surface of the vertical alignment film.

Further, according to the present invention, there is provided a method for producing a liquid crystal display element, the method including: applying an alignment material to at least one of a first substrate having a common electrode and a second substrate having a pixel electrode, the alignment material containing a polymerizable compound having a reactive group and a vertical alignment material; heating the applied alignment material to form an alignment film; interposing a liquid crystal composition containing a polymerizable compound between the first substrate and the second substrate; and irradiating the alignment film with an active energy ray while applying a voltage between the common electrode and the pixel electrode to polymerize the polymerizable compound in the alignment film and the polymerizable compound in the liquid crystal composition.

### Advantageous Effects of Invention

According to the present invention, high-speed responsiveness of the liquid crystal display element is excellent, alignment properties and pre-tilt angles of liquid crystal molecules are stable, ghosting is less likely to occur, and drop marks are less likely to occur in the production of the liquid crystal display element. Thus, the liquid crystal display element can be effectively used as a display element for liquid crystal TVs, monitors, and the like.

In addition, according to the present invention, the liquid crystal display element can be produced effectively while suppressing occurrence of drop marks.

### BRIEF DESCRIPTION OF DRAWINGS

FIG. 1 is a schematic cross-sectional view illustrating an embodiment of a liquid crystal display element of the present invention.

FIG. 2 is a schematic plan view illustrating an example of a slit electrode (comb-shaped electrode) to be used in the liquid crystal display element of the present invention.

FIG. 3 is a view illustrating the definition of a pre-tilt angle in the liquid crystal display element of the present invention.

### MODE FOR CARRYING OUT THE INVENTION

Embodiments of a liquid crystal display element and a method for producing the same of the present invention will be described.

Incidentally, the embodiments are provided to specifically describe and promote better understanding of the gist of the invention and do not limit the present invention unless otherwise noted.

### [Liquid Crystal Display Element]

A liquid crystal display element of the present invention includes a liquid crystal composition layer interposed between a pair of substrates and is based on the principle that liquid crystal molecules in a liquid crystal composition layer work as an optical switch under application of a voltage by Freedericksz transition. With regard to this, a known technology can be used.

Two substrates have electrodes for causing liquid crystal molecules to undergo Freedericksz transition. In a common vertical alignment liquid crystal display element, a technique of vertically applying an electrical charge between the two substrates is generally employed. In this case, one of the electrodes is configured as a common electrode and the other electrode is configured as a pixel electrode. Hereinafter, the most typical embodiment of this technique is described.

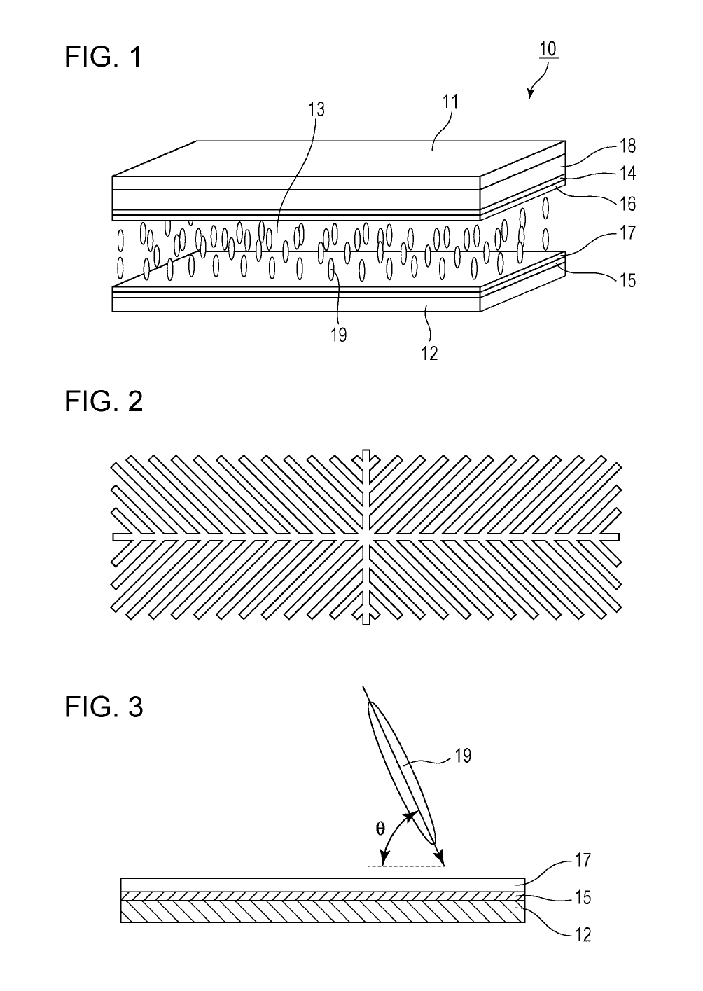

FIG. 1 is a schematic cross-sectional view illustrating an embodiment of a liquid crystal display element of the present invention.

A liquid crystal display element 10 of this embodiment is schematically configured to include: a first substrate 11; a second substrate 12; a liquid crystal composition layer 13 interposed between the first substrate 11 and the second substrate 12; a common electrode 14 provided on a surface, which faces the liquid crystal composition layer 13, of the first substrate 11; a pixel electrode 15 provided on a surface, which faces the liquid crystal composition layer 13, of the second substrate 12; a vertical alignment film 16 provided on a surface, which faces the liquid crystal composition layer 13, of the common electrode 14; a vertical alignment film 17 provided on a surface, which faces the liquid crystal composition layer 13, of the pixel electrode 15; a polymer layer 20 formed on the vertical alignment film 16; a polymer layer 21 formed on the vertical alignment film 17; and a color filter 18 provided between the first substrate 11 and the common electrode 14.

Glass substrates or plastic substrates are used as the first substrate 11 and the second substrate 12. Examples of the plastic substrate include substrates formed by a resin such as an acrylic resin, a methacrylic resin, polyethylene terephthalate, polycarbonate, and a cyclic olefin resin.

The common electrode 14 is usually composed of a material, such as indium-doped tin oxide (ITO), having transparency.

The pixel electrode 15 is usually composed of a material, such as indium-doped tin oxide (ITO), having transparency. The pixel electrode 15 formed on the second substrate 12 has a matrix shape. The pixel electrode 15 is controlled by drain electrodes of active elements as typified by TFT switching elements. The TFT switching elements have gate lines which are address signal lines and source lines which are data lines arranged in a matrix. Incidentally, herein, the configuration of the TFT switching elements is not illustrated in the drawings.

In a case where a pixel is divided into a number of domains to tilt liquid crystal molecules in the pixel in several different directions in order to improve the viewing angle characteristics, a pixel electrode that has slits (portions in which no electrode is formed) in a stripe pattern or a V-shape pattern may be provided in each pixel.

FIG. 2 is a schematic plan view illustrating a typical form of a slit electrode (comb-shape electrode) when a pixel is divided into four domains. This slit electrode has comb-tooth slits extending in four directions from the center of the pixel, and thus with no voltage applied, the liquid crystal molecules are aligned substantially vertically to the substrates in each pixel, while with a voltage applied, the liquid crystal molecular directors are directed in four different directions and come close to horizontal alignment. As a result, the alignment direction of liquid crystal in a pixel can be divided into plural directions, thereby causing a very wide viewing angle characteristic.

In addition to the method of providing slits in the pixel electrode, as the method of dividing a pixel, a method with which structures such as linear projections and the like are formed in a pixel, a method with which electrodes other than the pixel electrode and the common electrode are formed, and the like are used. The alignment direction of liquid crystal molecule can be divided by any one of these methods, but a configuration using a slit electrode is preferable in view of transmittance and the ease of production. A pixel electrode provided with slits has no driving force to liquid crystal molecule with no voltage applied, and thus a pre-tilt angle cannot be provided to liquid crystal molecules. However, a pre-tilt angle can be provided by using an alignment film material used in the present invention, and a wide viewing angle can be achieved by pixel division performed by combination with a slit electrode for dividing a pixel.

In the present invention, having a pre-tilt angle refers to a state in which with no voltage applied, the liquid crystal molecular directors are slightly different from a direction vertical to a substrate surface (a surface of the first substrate 11 or the surface of the second substrate 12 adjacent to the liquid crystal composition layer 13).

The liquid crystal display element of the present invention is a vertical alignment (VA)-mode liquid crystal display element, and thus with no voltage applied, the liquid crystal molecular directors are aligned substantially vertically to the substrate surface. In order to vertically align liquid crystal molecules, a vertical alignment film is generally used. As a material forming a vertical alignment film (vertical alignment film material), polyimide, polyamide, polysiloxane, or the like is used. Among these, polyimide is preferable. The vertical alignment film material may contain a mesogenic moiety, but, unlike a polymerizable compound to be described below, the vertical alignment film material preferably does not contain a mesogenic moiety. When the vertical alignment film material contains a mesogenic moiety, repeated application of a voltage may cause ghosting or the like due to disturbance in a molecular arrangement. In a case where the vertical alignment film is composed of polyimide, it is preferable to use a polyimide solution prepared by dissolving or dispersing a mixture of tetracarboxylic dianhydride and diisocyanate, polyamic acid, and polyimide in a solvent. In this case, the content of polyimide in the polyimide solution is preferably 1% by mass or more but 10% by mass or less, more preferably 3% by mass or more but 5% by mass or less, and even more preferably 10% by mass or less.

On the other hand, in a case where a polysiloxane-based vertical alignment film is used, a polysiloxane solution prepared by dissolving polysiloxane can be used, the polysiloxane being produced by mixing a silicon compound having an alkoxy group, an alcohol derivative, and an oxalic acid derivative at a predetermined mixing amount ratio and then heating the resultant mixture.

In the liquid crystal display element of the present invention, the vertical alignment films 16 and 17 formed by polyimide or the like contain a polymer formed by polymerization of a polymerizable compound having a reactive group. This polymerizable compound provides the function of fixing the pre-tilt angle of liquid crystal molecules after polymerization. That is, with a voltage applied, the liquid crystal molecular directors in a pixel can be tilted in different directions by using a slit electrode or the like. However, even in a configuration using a slit electrode, with no voltage applied, liquid crystal molecules are aligned substantially vertically to the substrate surface, and thus a pre-tilt angle is not produced. When a voltage is applied between electrodes and the reactive monomer in the liquid crystal composition is polymerized by irradiation with an ultraviolet ray while liquid crystal molecules are slightly tilted, a proper pre-tilt angle is provided.

Further, the polymer layers 20 and 21 are formed as a polymer on the surfaces of the vertical alignment films 16 and 17 in such a manner that a polymerizable compound contained in the liquid crystal composition is interposed between the substrates, the polymerizable compound is cured while a voltage is applied, and thus the polymerizable compound is phase-separated.

Owing to the polymers contained in the vertical alignment films 16 and 17 and the polymer layers 20 and 21 formed on the surfaces of the vertical alignment films 16 and 17, the liquid crystal display element in which stability of the alignment property and pre-tilt angles of liquid crystal molecules are high, ghosting is less likely to occur, and drop marks are less likely to occur in the production of the liquid crystal display element is obtained.

In the present invention, “substantially vertical” means a state in which the directors of vertically aligned liquid crystal molecules are slightly fallen from the vertical direction to provide a pre-tilt angle. When pre-tilt angles incompletely vertical alignment and homogeneous alignment (horizontal alignment to the substrate surface) are 90° and 0°, respectively, the pre-tilt angle in substantially vertical alignment is preferably 89 to 85° and more preferably 89 to 87°.

The vertical alignment films 16 and 17 that contain a polymer of a polymerizable compound having a reactive group are formed by an effect of the polymerizable compound mixed in the vertical alignment film material. Therefore, it is speculated that the vertical alignment film and the polymerizable compound are intricately entangled to form a type of a polymer alloy; however, the exact structure thereof cannot be identified.

The polymer layers 20 and 21 are formed on the surfaces of the vertical alignment films 16 and 17 in such a manner that a polymerizable compound contained in the liquid crystal composition is phase-separated when the polymerizable compound is polymerized. However, it is considered that whether the polymer layers 20 and 21 are formed uniformly on the entire surface of the vertical alignment film or are formed to have a non-uniform sea-island structure depends on production conditions, and the exact structure thereof cannot be identified. In FIG. 1, a case where the polymer layers are uniformly formed is illustrated.

### (Polymerizable Compound Having Reactive Group Contained in Vertical Alignment Film)

Examples of the polymerizable compound having a reactive group include a monofunctional polymerizable compound having one reactive group and a polyfunctional compound having two or more reactive groups such as a bifunctional or trifunctional polymerizable compound, but may be one or two or more kinds. A polymerizable compound having a reactive group may or may not contain a mesogenic moiety.

The reactive group in the polymerizable compound having a reactive group is preferably a photopolymerizable substituent. In particular, the reactive group is particularly preferably a photopolymerizable substituent since, when the vertical alignment film is formed by thermal polymerization, the reaction of the polymerizable compound having a reactive group can be suppressed at the time of thermal polymerization of the vertical alignment film material.

As the monofunctional polymerizable compound having a reactive group among polymerizable compounds having a reactive group, specifically, a polymerizable compound represented by the following General Formula (VI) is preferable.

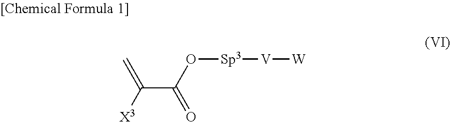

(In the formula, X³ represents a hydrogen atom or a methyl group; Sp³ represents a single bond, an alkylene group having 1 to 8 carbon atoms, or —O—(CH₂)ₜ— (in the formula, t represents an integer of 2 to 7 and the oxygen atom is to bond with an aromatic ring); V represents a linear or branched polyvalent alkylene group having 2 to 20 carbon atoms or a polyvalent cyclic substituent having 5 to 30 carbon atoms; an alkylene group in the polyvalent alkylene group may be substituted with an oxygen atom as long as the oxygen atoms are not adjacent to each other or may be substituted with an alkyl group having 5 to 20 carbon atoms (an alkylene group in the group may be substituted with an oxygen atom as long as the oxygen atoms are not adjacent to each other) or a cyclic substituent; and W represents a hydrogen atom, a halogen atom, or an alkylene group having 1 to 8 carbon atoms.)

In the above General Formula (VI), X³ represents a hydrogen atom or a methyl group. If the reaction speed is important, a hydrogen atom is preferable. If reducing the amount of reaction residues is important, a methyl group is preferable.

In the above General Formula (VI), Sp³ represents a single bond, an alkylene group having 1 to 8 carbon atoms, or —O—(CH₂)ₜ— (in the formula, t represents an integer of 2 to 7 and the oxygen atom is to bond with an aromatic ring). However, the carbon chain is preferably not long. A single bond or an alkylene group having 1 to 5 carbon atoms is preferable, and a single bond or an alkylene group having 1 to 3 carbon atoms is more preferable. In addition, when Sp³ represents —O—(CH₂)ₜ—, t is preferably 1 to 5 and more preferably 1 to 3.

In the above General Formula (VI), V represents a linear or branched polyvalent alkylene group having 2 to 20 carbon atoms or a polyvalent cyclic substituent having 5 to 30 carbon atoms. However, an alkylene group in the polyvalent alkylene group may be substituted with an oxygen atom as long as the oxygen atoms are not adjacent to each other or may be substituted with an alkyl group having 5 to 20 carbon atoms (an alkylene group in the group may be substituted with an oxygen atom as long as the oxygen atoms are not adjacent to each other) or a cyclic substituent, and is preferably substituted with two or more cyclic substituents.

More specifically, examples of the polymerizable compound represented by General Formula (VI) include a compound represented by General Formula (X1a):

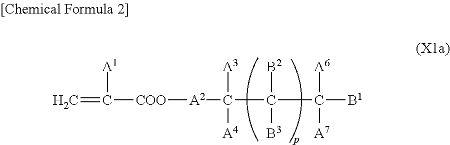

(in formula, A¹ represents a hydrogen atom or a methyl group;

A² represents a single bond or an alkylene group having 1 to 8 carbon atoms (one or two or more methylene groups in the alkylene group each independently may be substituted with an oxygen atom, —CO—, —COO—, or —OCO—, provided that oxygen atoms are not directly bonded to each other, and one or two or more hydrogen atoms in the alkylene group each independently may be substituted with a fluorine atom, a methyl group, or an ethyl group);

A³ and A⁶ each independently represent a hydrogen atom, a halogen atom, or an alkyl group having 1 to 10 carbon atoms (one or two or more methylene groups in the alkyl group each independently may be substituted with an oxygen atom, —CO—, —COO—, or —OCO—, provided that oxygen atoms are not directly bonded to each other, and one or two or more hydrogen atoms in the alkyl group each independently may be substituted with a halogen atom or an alkyl group having 1 to 17 carbon atoms);

A⁴ and A⁷ each independently represent a hydrogen atom, a halogen atom, or an alkyl group having 1 to 10 carbon atoms (one or two more methylene groups in the alkyl group each independently may be substituted with an oxygen atom, —CO—, —COO—, or —OCO—, provided that oxygen atoms are not directly bonded to each other, and one or two or more hydrogen atoms in the alkyl group each independently may be substituted with a halogen atom or an alkyl group having 1 to 9 carbon atoms);

p represents 1 to 10; and

B¹, B², and B³ each independently represent a hydrogen atom or a linear or branched alkyl group having 1 to 10 carbon atoms (one or two or more methylene groups in the alkyl group each independently may be substituted with an oxygen atom, —CO—, —COO—, or —OCO—, provided that oxygen atoms are not directly bonded to each other, and one or two or more hydrogen atoms in the alkyl group each independently may be substituted with a halogen atom or a trialkoxysilyl group having 3 to 6 carbon atoms).

In addition, specific examples of the polymerizable compound represented by General Formula (VI) also include a compound represented by General Formula (X1b):

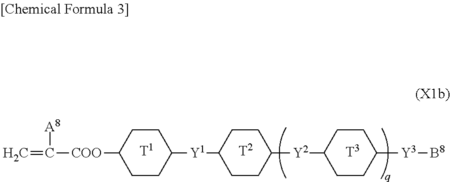

(in the formula, A⁸ represents a hydrogen atom or a methyl group;

6-membered rings T¹, T², and T³ each independently represent any of the following structures:

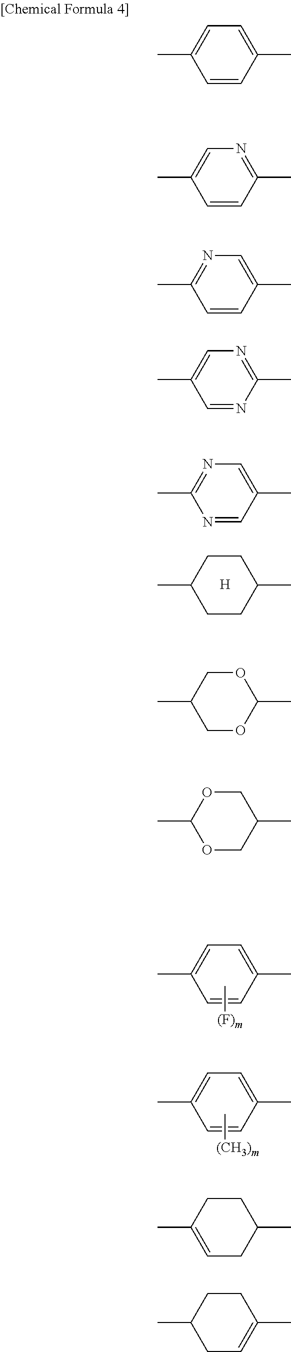

(provided that, q represents an integer of 1 to 4);

q represents 0 or 1;

Y¹ and Y² each independently represent a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH₂═CHCH₂CH₂—, or —CH₂CH₂CH═CH—;

Y³ represents a single bond, —COO—, or —OCO—; and

B⁸ represents a hydrocarbon group having 1 to 18 carbon atoms).

Furthermore, specific examples of the polymerizable compound represented by General Formula (VI) also include a compound represented by General Formula (X1c):

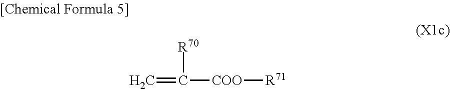

(in the formula, R⁷⁰ represents a hydrogen atom or a methyl group; and R⁷¹ represents a hydrocarbon group having a condensed ring).

The polyfunctional polymerizable compound having a reactive group among polymerizable compounds having a reactive group is preferably a polymerizable compound represented by the following General Formula (V):

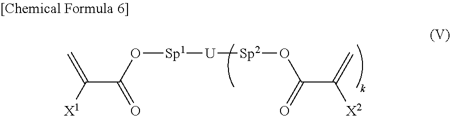

(in the formula, X¹ and X² each independently represent a hydrogen atom or a methyl group; Sp¹ and Sp² each independently represent a single bond, an alkylene group having 1 to 8 carbon atoms, or —O—(CH₂)ₛ— (in the formula, s represents an integer of 2 to 7, and the oxygen atom is to bond with an aromatic ring); U represents a linear or branched polyvalent alkylene group having 2 to 20 carbon atoms or a polyvalent cyclic substituent having 5 to 30 carbon atoms; an alkylene group in the polyvalent alkylene group may be substituted with an oxygen atom as long as the oxygen atoms are not adjacent to each other or may be substituted with an alkyl group having 5 to 20 carbon atoms (an alkylene group in the group may be substituted with an oxygen atom as long as the oxygen atoms are not adjacent to each other) or a cyclic substituent; and k represents an integer of 1 to 5).

In the above General Formula (V), X¹ and X² each independently represent a hydrogen atom or a methyl group. If the reaction speed is important, a hydrogen atom is preferable. If reducing the amount of reaction residues is important, a methyl group is preferable.

In the above General Formula (V), Sp¹ and Sp² each independently represent a single bond, an alkylene group having 1 to 8 carbon atoms, or —O—(CH₂)ₛ— (in the formula, s represents an integer of 2 to 7 and the oxygen atom is to bond with an aromatic ring). However, the carbon chain is preferably not long. A single bond or an alkylene group having 1 to 5 carbon atoms is preferable, and a single bond or an alkylene group having 1 to 3 carbon atoms is more preferable. In addition, when Sp¹ and Sp² represent —O—(CH₂)ₛ—, s is preferably 1 to 5 and more preferably 1 to 3. At least one of Sp¹ and Sp² is preferably a single bond and both of them are particularly preferably a single bond.

In the above General Formula (V), U represents a linear or branched polyvalent alkylene group having 2 to 20 carbon atoms or a polyvalent cyclic substituent having 5 to 30 carbon atoms. However, an alkylene group in the polyvalent alkylene group may be substituted with an oxygen atom as long as the oxygen atoms are not adjacent to each other or may be substituted with an alkyl group having 5 to 20 carbon atoms (an alkylene group in the group may be substituted with an oxygen atom as long as the oxygen atoms are not adjacent to each other) or a cyclic substituent, and is preferably substituted with two cyclic substituents.

In the General Formula (V), specifically, U is preferably represented by the following Formula (Va-1) to Formula (Va-5), more preferably represented by the following Formula (Va-1) to Formula (Va-3), and particularly preferably represented by the following Formula (Va-1).

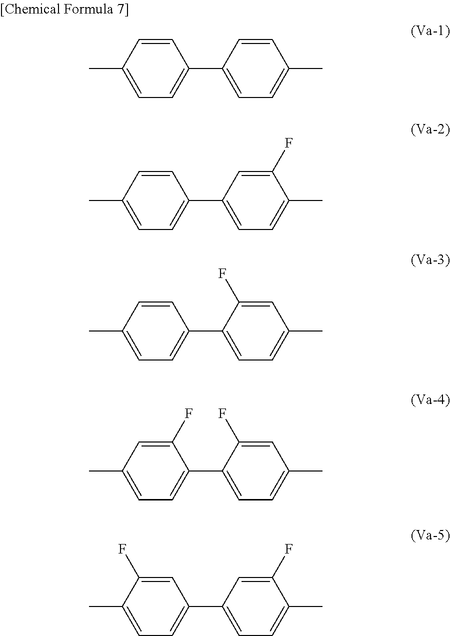

(In the formula, each end is bonded to Sp¹ or Sp².)

When U has a cyclic structure, at least one of Sp¹ and Sp² preferably represents a single bond, and both of them are also preferably a single bond.

In the above General Formula (V), k represents an integer of 1 to 5, but a bifunctional compound having k representing 1 or a trifunctional compound having k representing 2 is preferable, and a bifunctional compound is more preferable.

The compound represented by the above General Formula (V) is specifically preferably a compound represented by the following General Formula (Vb).

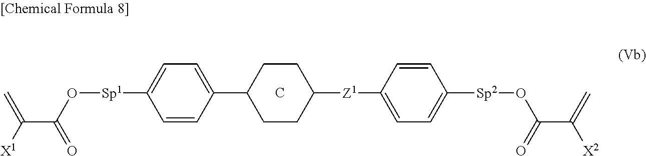

(In the formula, X¹ and X² each independently represent a hydrogen atom or a methyl group; Sp¹ and Sp² each independently represent a single bond, an alkylene group having 1 to 8 carbon atoms, or —O—(CH₂)ₛ— (in the formula, s represents an integer of 2 to 7 and the oxygen atom is to bond with an aromatic ring); Z¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²—, —C≡C—, or a single bond; C represents a 1,4-phenylene group, a trans-1,4-cyclohexylene group, or a single bond; and in all the 1,4-phenylene groups in the formula, any of hydrogen atoms may be substituted with fluorine atoms.)

In the above General Formula (Vb), X¹ and X² each independently represent a hydrogen atom or a methyl group, but both of them are preferably a diacrylate derivative representing a hydrogen atom or a dimethacrylate derivative having a methyl group, and are also preferably a compound in which one of X¹ and X² represents a hydrogen atom and the other represents a methyl group. Among these compounds, the diacrylate derivative has the highest rate of polymerization, the dimethacrylate derivative has a low rate of polymerization, and the asymmetrical compound has an intermediate rate of polymerization. A preferred one can be used in accordance with the applications. In a PSA liquid crystal display element, the dimethacrylate derivative is particularly preferably used.

In the above General Formula (Vb), Sp¹ and Sp² each independently represent a single bond, an alkylene group having 1 to 8 carbon atoms, or —O—(CH₂)s-, but at least one of Sp¹ and Sp² preferably represents a single bond. A compound in which Sp¹ and Sp² each represent a single bond or a compound in which one of Sp¹ and Sp² represents a single bond and the other represents an alkylene group having 1 to 8 carbon atoms or —O—(CH₂)s- is preferable. In this case, an alkylene group having 1 to 4 carbon atoms is preferable and s is preferably 1 to 4.

In the above General Formula (Vb), Z¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²—, —C≡C—, or a single bond, but is preferably —OCH₂—, —CH₂O—, —COO—, —OCO—, —CF₂O—, —OCF₂—, —CH₂CH₂—, —CF₂CF₂—, or a single bond, more preferably —COO—, —OCO—, or a single bond, and particularly preferably a single bond.

In the above General Formula (Vb), C represents a 1,4-phenylene group in which any of hydrogen atoms may be substituted with fluorine atoms, a trans-1,4-cyclohexylene group, or a single bond, but is preferably a 1,4-phenylene group or a single bond.

When C represents a cyclic structure other than a single bond, Z¹ is preferably a linking group other than a single bond. When C is a single bond, Z¹ is preferably a single bond.

From the above-described description, in the above General Formula (Vb), a case where C represents a single bond and the cyclic structure is constituted by two rings is preferable. As the polymerizable compound having a cyclic structure, specifically, compounds represented by the following General Formulae (V-1) to (V-6) are preferable, compounds represented by General Formulae (V-1) to (V-4) are particularly preferable, and a compound represented by General Formula (V-2) is most preferable.

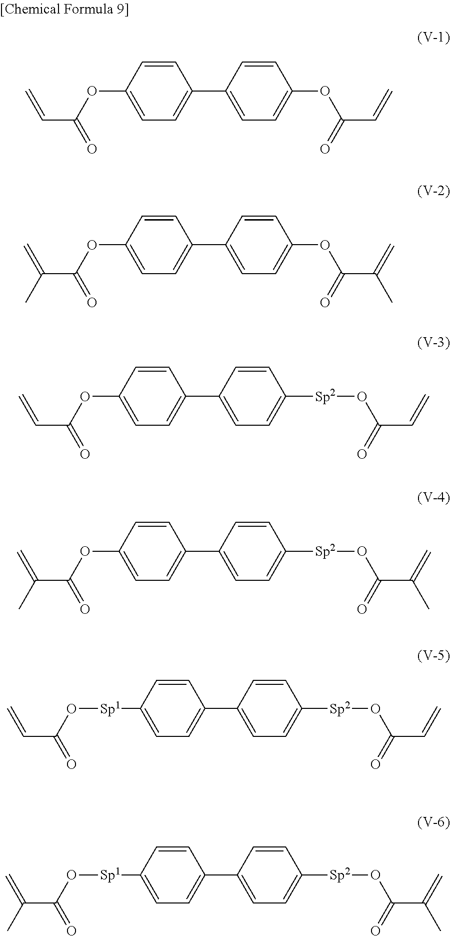

The compound represented by the above General Formula (V) is specifically preferably a compound represented by the following General Formula (Vc).

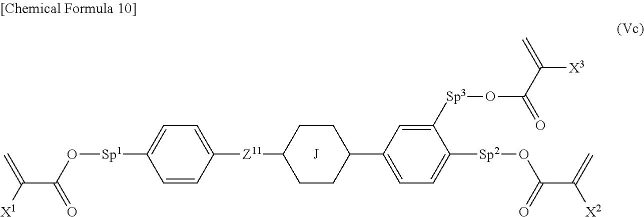

(In the formula, X¹, X², and X³ each independently represent a hydrogen atom or a methyl group; Sp¹, Sp² and Sp³ each independently represent a single bond, an alkylene group having 1 to 8 carbon atoms, or —O—(CH₂)ₛ— (in the formula, s represents an integer of 2 to 7 and the oxygen atom is to bond with an aromatic ring); Z¹¹ and Z¹² each independently represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²—, —C≡C—, or a single bond; J represents a 1,4-phenylene group, a trans-1,4-cyclohexylene group, or a single bond; and in all the 1,4-phenylene groups in the formula, any of hydrogen atoms may be substituted with fluorine atoms.)

### (Polymerizable Compound for Forming Polymer Layer Contained in Liquid Crystal Composition)

Examples of the polymerizable compound forming the polymerization layer include a monofunctional polymerizable compound having one reactive group and a polyfunctional polymerizable compound having two or more reactive groups such as a bifunctional or trifunctional polymerizable compound, but a polyfunctional polymerizable compound having two or more reactive groups such as a bifunctional or trifunctional polymerizable compound is preferable. A polymerizable compound to be used may be one or two or more kinds. A polymerizable compound having a reactive group preferably contains a mesogenic moiety.

The polymerizable compound forming a polymerization layer is more specifically preferably a polymerizable compound represented by the following General Formula (V):

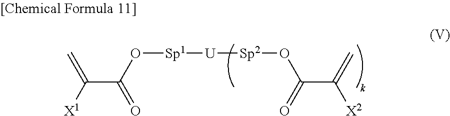

(in the formula, X¹ and X² each independently represent a hydrogen atom or a methyl group; Sp¹ and Sp² each independently represent a single bond, an alkylene group having 1 to 8 carbon atoms, or —O—(CH₂)ₛ— (in the formula, s represents an integer of 2 to 7 and the oxygen atom is to bond with an aromatic ring); U represents a linear or branched polyvalent alkylene group having 2 to 20 carbon atoms or a polyvalent cyclic substituent having 5 to 30 carbon atoms; an alkylene group in the polyvalent alkylene group may be substituted with an oxygen atom as long as the oxygen atoms are not adjacent to each other or may be substituted with an alkyl group having 5 to 20 carbon atoms (an alkylene group in the formula may be substituted with an oxygen atom as long as the oxygen atoms are not adjacent to each other) or a cyclic substituent; and k represents an integer of 1 to 5).

In the above General Formula (V), X¹ and X² each independently represent a hydrogen atom or a methyl group. If the reaction speed is important, a hydrogen atom is preferable. If reducing the amount of reaction residues is important, a methyl group is preferable.

In the above General Formula (V), Sp¹ and Sp² each independently represent a single bond, an alkylene group having 1 to 8 carbon atoms, or —O—(CH₂)ₛ— (in the formula, s represents an integer of 2 to 7 and the oxygen atom is to bond with an aromatic ring). However, the carbon chain is preferably not long. A single bond or an alkylene group having 1 to 5 carbon atoms is preferable, and a single bond or an alkylene group having 1 to 3 carbon atoms is more preferable. In addition, when Sp¹ and Sp² represent —O—(CH₂)ₛ—, s is preferably 1 to 5 and more preferably 1 to 3. At least one of Sp¹ and Sp² is more preferably a single bond and both of them are particularly preferably a single bond.

In the above General Formula (V), U represents a linear or branched polyvalent alkylene group having 2 to 20 carbon atoms or a polyvalent cyclic substituent having 5 to 30 carbon atoms, but an alkylene group in the polyvalent alkylene group may be substituted with an oxygen atom as long as the oxygen atoms are not adjacent to each other or may be substituted with an alkyl group having 5 to 20 carbon atoms (an alkylene group in the formula may be substituted with an oxygen atom as long as the oxygen atoms are not adjacent to each other) or a cyclic substituent, and is preferably substituted with two or more cyclic substituents.

In the above General Formula (V), U is specifically preferably represented by the following Formula (Va-1) to Formula (Va-5), more preferably represented by Formula (Va-1) to Formula (Va-3), and particularly preferably represented by Formula (Va-1).

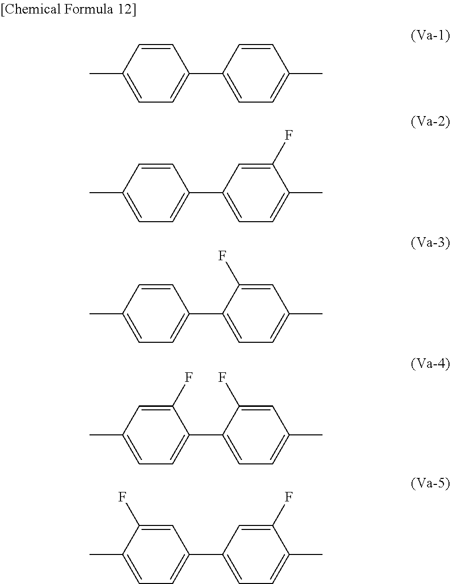

(In the formula, each end is bonded to Sp¹ or Sp².)

When U has a cyclic structure, at least one of Sp¹ and Sp² preferably represents a single bond, and both of them are also preferably a single bond.

In the above General Formula (V), k represents an integer of 1 to 5, but a bifunctional compound having k representing 1 or a trifunctional compound having k representing 2 is preferable, and a bifunctional compound is more preferable.

The compound represented by the above General Formula (V) is specifically preferably a compound represented by the following General Formula (Vb).

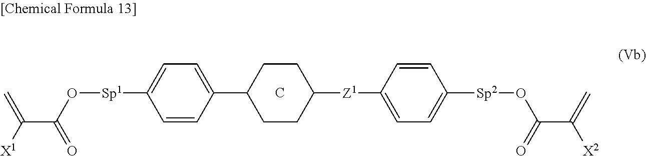

(In the formula, X¹ and X² each independently represent a hydrogen atom or a methyl group; Sp¹ and Sp² each independently represent a single bond, an alkylene group having 1 to 8 carbon atoms, or —O—(CH₂)ₛ— (in the formula, s represents an integer of 2 to 7 and the oxygen atom is to bond with an aromatic ring); Z¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²—, —C≡C—, or a single bond; C represents a 1,4-phenylene group, a trans-1,4-cyclohexylene group, or a single bond; and in all the 1,4-phenylene groups in the formula, any of hydrogen atoms may be substituted with fluorine atoms.)

In the above General Formula (Vb), X¹ and X² each independently represent a hydrogen atom or a methyl group, but both of them are preferably a diacrylate derivative representing a hydrogen atom or a dimethacrylate derivative having a methyl group, and are also preferably a compound in which one of X¹ and X² represents a hydrogen atom and the other represents a methyl group. Among these compounds, the diacrylate derivative has the highest rate of polymerization, the dimethacrylate derivative has a low rate of polymerization, and the asymmetrical compound has an intermediate rate of polymerization. A preferred one can be used in accordance with the applications. In a PSA liquid crystal display element, the dimethacrylate derivative is particularly preferably used.

In the above General Formula (Vb), Sp¹ and Sp² each independently represent a single bond, an alkylene group having 1 to 8 carbon atoms, or —O—(CH₂)s-, but at least one of Sp¹ and Sp² preferably represents a single bond. A compound in which Sp¹ and Sp² each represent a single bond or a compound in which one of Sp¹ and Sp² represents a single bond and the other represents an alkylene group having 1 to 8 carbon atoms or —O—(CH₂)s- is preferable. In this case, an alkylene group having 1 to 4 carbon atoms is preferable and s is preferably 1 to 4.

In the above General Formula (Vb), Z¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²—, —C≡C—, or a single bond, but is preferably —OCH₂—, —CH₂O—, —COO—, —COO—, —CF₂O—, —OCF₂—, —CH₂CH₂—, —CF₂CF₂—, or a single bond, more preferably —COO—, —OCO—, or a single bond, and particularly preferably a single bond.

In the above General Formula (Vb), C represents a 1,4-phenylene group in which any of hydrogen atoms may be substituted with fluorine atoms, a trans-1,4-cyclohexylene group, or a single bond, but is preferably a 1,4-phenylene group or a single bond.

When C represents a cyclic structure other than a single bond, Z¹ is preferably a linking group other than a single bond. When C is a single bond, Z¹ is preferably a single bond.

From the above-described description, in the above General Formula (Vb), a case where C represents a single bond and the cyclic structure is constituted by two rings is preferable. As the polymerizable compound having a cyclic structure, specifically, compounds represented by the following General Formulae (V-1) to (V-6) are preferable, compounds represented by General Formulae (V-1) to (V-4) are particularly preferable, and a compound represented by General Formula (V-2) is most preferable.

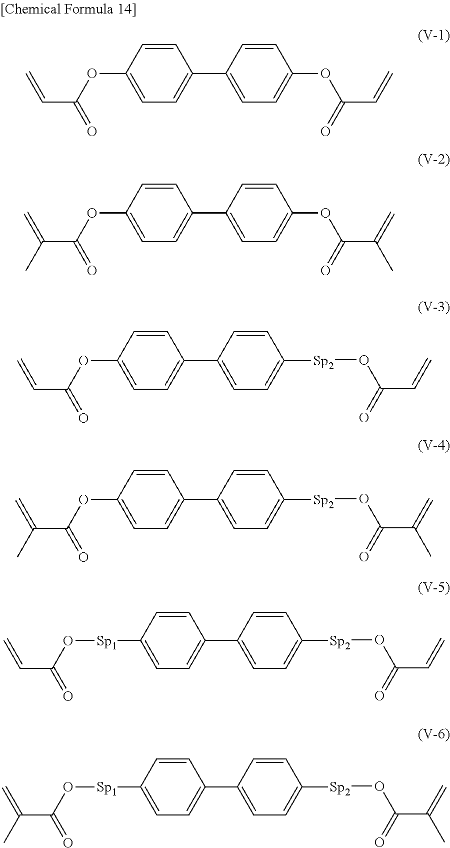

The compound represented by the above General Formula (V) is specifically preferably a compound represented by the following General Formula (Vc).

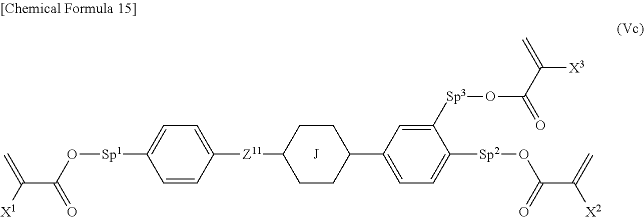

(In the formula, X¹, X², and X³ each independently represent a hydrogen atom or a methyl group; Sp¹, Sp² and Sp³ each independently represent a single bond, an alkylene group having 1 to 8 carbon atoms, or —O—(CH₂)ₛ— (in the formula, s represents an integer of 2 to 7 and the oxygen atom is to bond with an aromatic ring); Z¹¹ and Z¹² each independently represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²—, —C≡C—, or a single bond; J represents a 1,4-phenylene group, a trans-1,4-cyclohexylene group, or a single bond; and in all the 1,4-phenylene groups in the formula, any of hydrogen atoms may be substituted with fluorine atoms.)

### (Liquid Crystal Composition)

In the liquid crystal composition of the present invention, as a first component, a compound represented by the following General Formula (I) is contained preferably in an amount of 25 to 70% by mass, more preferably in an amount of 30 to 60% by mass, even more preferably in an amount of 35 to 50% by mass, and most preferably in an amount of 38 to 47% by mass.

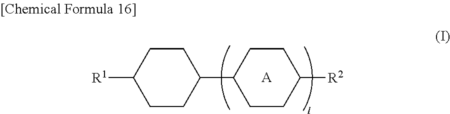

(in the formula, R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; A represents a 1,4-phenylene group or a trans-1,4-cyclohexylene group; 1 represents 1 or 2; and when 1 is 2, two A may be the same as or different from each other.)

In the above General Formula (I), R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms.

R¹ and R² preferably represent an alkyl group having 1 to 5 carbon atoms, an alkenyl group having 2 to 5 carbon atoms, an alkoxy group having 1 to 5 carbon atoms, or an alkenyloxy group having 2 to 5 carbon atoms.

R¹ and R² more preferably represent an alkyl group having 2 to 5 carbon atoms, an alkenyl group having 2 to 4 carbon atoms, an alkoxy group having 1 to 4 carbon atoms, or an alkenyloxy group having 2 to 4 carbon atoms.

R¹ and R² particularly preferably represent an alkyl group having 2 to 5 carbon atoms or an alkenyl group having 2 to 4 carbon atoms.

When R¹ represents an alkyl group, an alkyl group having 1, 3, or 5 carbon atoms is particularly preferable. When R¹ represents an alkenyl group, the following structures are preferable.

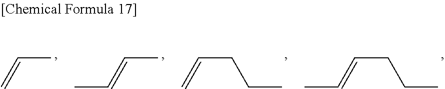

(In the formula, the end on the right-hand side is bonded to the cyclic structure.)

Of the above-described structures, a vinyl group or a 1-propenyl group which is an alkenyl group having 2 or 3 carbon atoms is even more preferable.

In the above General Formula (I), R¹ and R² may be the same as or different from each other but are preferably different from each other. When both R¹ and R² are an alkyl group, they are particularly preferably alkyl groups having 1, 3, or 5 carbon atoms with the number of carbon atoms different from each other.

The content of the compound represented by the above General Formula (I) in which at least one substituent selected from R¹ and R² is an alkyl group having 3 to 5 carbon atoms is preferably 50% by mass or more, more preferably 70% by mass or more, and even more preferably 80% by mass or more in the compound represented by the above General Formula (I).

In addition, the content of the compound represented by the above General Formula (I) in which at least one substituent selected from R¹ and R² is an alkyl group having 3 carbon atoms is preferably 50% by mass or more, more preferably 70% by mass or more, even more preferably 80% by mass or more, and most preferably 100% in the compound represented by the above General Formula (I).

In the above General Formula (I), A represents a 1,4-phenylene group or a trans-1,4-cyclohexylene group, but preferably represents a trans-1,4-cyclohexylene group. In addition, the content of the compound represented by the above General Formula (I) in which A represents a trans-1,4-cyclohexylene group is preferably 50% by mass or more, more preferably 70% by mass or more, and even more preferably 80% by mass or more in the compound represented by the above General Formula (I).

The compound represented by the above General Formula (I) is specifically preferably compounds represented by the following General Formula (Ia) to General Formula (Ik).

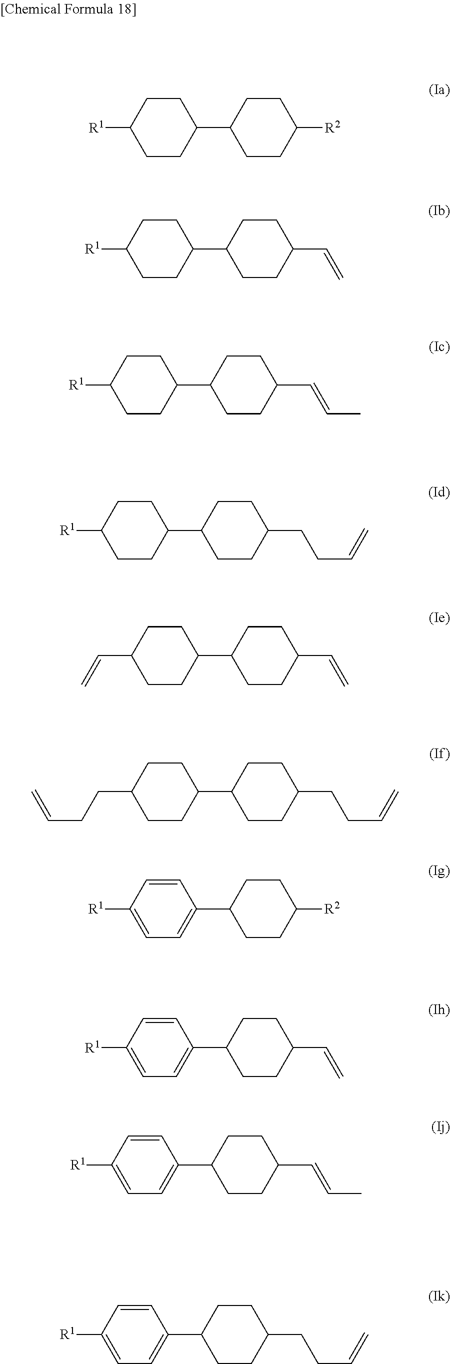

(In the formula, R¹ and R² each independently represent an alkyl group having 1 to 5 carbon atoms or an alkoxy group having 1 to 5 carbon atoms, but are preferably similar to the embodiments of R¹ and R² in General Formula (I).)

Among the above General Formula (Ia) to General Formula (Ik), General Formula (Ia), General Formula (Ib), and General Formula (Ig) are preferable, and General Formula (Ia) and General Formula (Ig) are more preferable. In order to improve the response speed, reducing of ghosting property, and suppressing of drop marks with a good balance, General Formula (Ia) is particularly preferable. When the response speed is important, General Formula (Ib) is also preferable, and when the response speed is critical, General Formula (Ib), General Formula (Ie), General Formula (If), and General Formula (Ih) are preferable. Dialkenyl compounds represented by General Formula (Ie) and General Formula (If) are particularly preferable when the response speed is important.

From these points, the content of the compounds represented by the above General Formula (Ia) and General Formula (Ig) is preferably 50% by mass or more, more preferably 70% by mass or more, even more preferably 80% by mass or more, and most preferably 100% by mass in the compound represented by the above General Formula (I). In addition, the content of the compound represented by the above General Formula (Ia) is preferably 50% by mass or more, more preferably 70% by mass or more, and even more preferably 80% by mass or more in the compound represented by the above General Formula (I).

The liquid crystal composition of the present invention preferably contains, as a second component, a compound represented by the following General Formula (II).

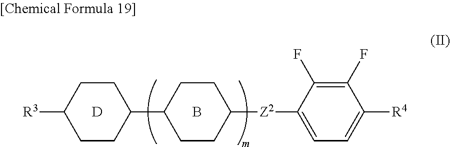

(in the formula, R³ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; R⁴ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms; B and D each independently represent a 1,4-phenylene group or a trans-1,4-cyclohexylene group; Z² represents a single bond, —OCH₂—, —OCO—, —CH₂O—, or —COO—; m represents 0, 1, or 2; and when m is 2, two B may be the same as or different from each other.)

m in the formula is preferably 1 or 2.

Examples of the compound represented by General Formula (II) having m representing 1 include compounds represented by the following General Formula (II-1), General Formula (II-1′) and, General Formula (II-2).

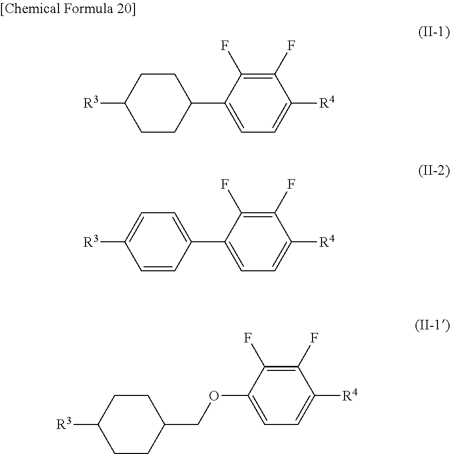

(In the formula, R³ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; and R⁴ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms.)

In the above General Formula (II-1) and General Formula (II-2), R³ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, but preferably represents an alkyl group having 1 to 5 carbon atoms or an alkenyl group having 2 to 5 carbon atoms, more preferably represents an alkyl group having 2 to 5 carbon atoms or an alkenyl group having 2 to 4 carbon atoms, even more preferably represents an alkyl group having 3 to 5 carbon atoms or an alkenyl group having 2 carbon atoms, and particularly preferably represents an alkyl group having 3 carbon atoms.

In the above General Formula (II-1) and General Formula (II-2), R⁴ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, but preferably represents an alkyl group having 1 to 5 carbon atoms or an alkoxy group having 1 to 5 carbon atoms, more preferably represents an alkyl group having 1 to 3 carbon atoms or an alkoxy group having 1 to 3 carbon atoms, even more preferably represents an alkyl group having 3 carbon atoms or an alkoxy group having 2 carbon atoms, and particularly preferably represents an alkoxy group having 2 carbon atoms.

The compounds represented by the above General Formula (II-1) and General Formula (II-2) are specifically preferably compounds represented by the following General Formula (II-1a) and General Formula (II-1b).

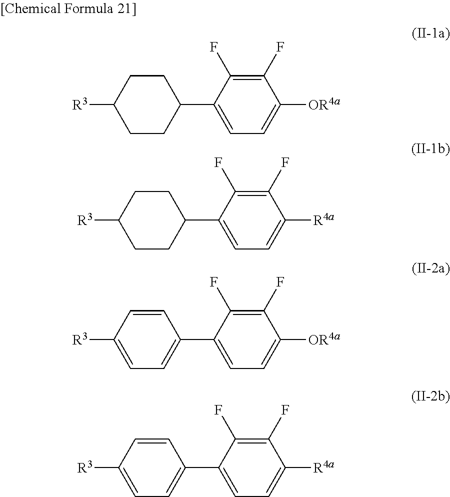

(In the formula, R³ represents an alkyl group having 1 to 5 carbon atoms or an alkenyl group having 2 to 5 carbon atoms; and R^{4a} represents an alkyl group having 1 to 5 carbon atoms.)

In the above General Formula (II-1a), R⁴ is preferably an alkyl group having 1 to 3 carbon atoms, more preferably an alkyl group having 1 or 2 carbon atoms, and particularly preferably an alkyl group having 2 carbon atoms.

In the above General Formula (II-1b), R⁴ is preferably an alkyl group having 1 to 3 carbon atoms, more preferably an alkyl group having 1 or 3 carbon atoms, and particularly preferably an alkyl group having 3 carbon atoms.

Of the above General Formula (II-1a) and General Formula (II-1b), General Formula (II-1a) is preferable in order to increase an absolute value of the dielectric anisotropy.

In the above General Formula (II-2a), R⁴ is preferably an alkyl group having 1 to 3 carbon atoms, more preferably an alkyl group having 1 or 2 carbon atoms, and particularly preferably an alkyl group having 2 carbon atoms.

In the above General Formula (II-2b), R⁴ is preferably an alkyl group having 1 to 3 carbon atoms, more preferably an alkyl group having 1 or 3 carbon atoms, and particularly preferably an alkyl group having 3 carbon atoms.

Of the above General Formula (II-2a) and General Formula (II-2b), General Formula (II-2a) is preferable in order to increase an absolute value of the dielectric anisotropy.

In the liquid crystal composition of the present invention, compounds represented by General Formula (II-1) and General Formula (II-2) are contained preferably in an amount of 5 to 30% by mass, more preferably in an amount of 10 to 25% by mass, and even more preferably in an amount of 12 to 20% by mass.

Specific examples of a compound represented by General Formula (II) having m representing 1 include a compound represented by the following General Formula (II-3).

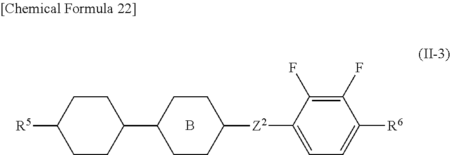

(In the formula, R⁵ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; R⁶ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms; B represents a 1,4-phenylene group or a trans-1,4-cyclohexylene group; and Z² represents a single bond, —OCH₂—, —OCO—, —CH₂O—, or —OCO—.)

In the above General Formula (II-3), R⁵ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, but preferably represents an alkyl group having 1 to 5 carbon atoms or an alkenyl group having 2 to 5 carbon atoms, more preferably represents an alkyl group having 2 to 5 carbon atoms or an alkenyl group having 2 to 4 carbon atoms, even more preferably represents an alkyl group having 3 to 5 carbon atoms or an alkenyl group having 2 carbon atoms, and particularly preferably represents an alkyl group having 3 carbon atoms.

In the above General Formula (II-3), R⁶ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, but preferably represents an alkyl group having 1 to 5 carbon atoms or an alkoxy group having 1 to 5 carbon atoms, more preferably represents an alkyl group having 1 to 3 carbon atoms or an alkoxy group having 1 to 3 carbon atoms, even more preferably represents an alkyl group having 3 carbon atoms or an alkoxy group having 2 carbon atoms, and particularly preferably represents an alkoxy group having 2 carbon atoms.

In the above General Formula (II-3), B represents a 1,4-phenylene group, which may be substituted with fluorine, or a trans-1,4-cyclohexylene group, but is preferably an unsubstituted 1,4-phenylene group or a trans-1,4-cyclohexylene group and more preferably a trans-1,4-cyclohexylene group.

In the above General Formula (II-3), Z² represents a single bond, —OCH₂—, —OCO—, —CH₂O—, or —COO—, but preferably represents a single bond or —CH₂O— and more preferably represents a single bond.

The compound represented by the above General Formula (II-3) is specifically preferably compounds represented by the following General Formula (II-3a) to General Formula (II-3f).

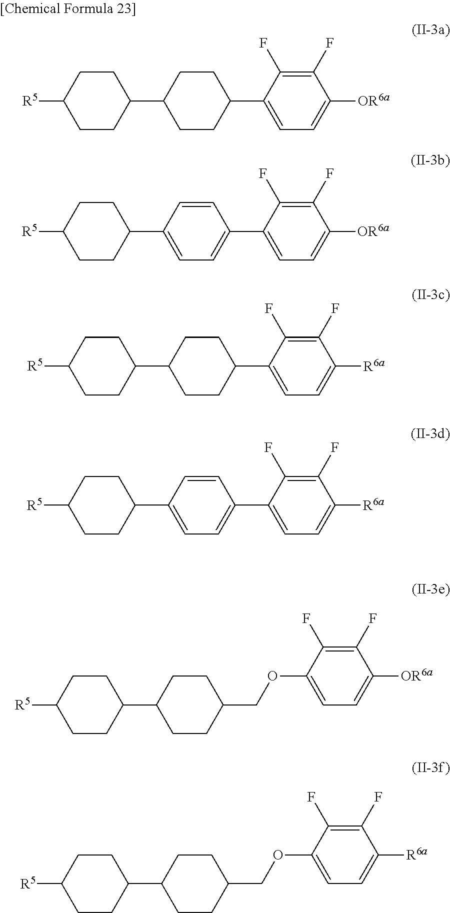

(In the formula, R⁵ represents an alkyl group having 1 to 5 carbon atoms or an alkenyl group having 2 to 5 carbon atoms, and R^{6a} represents an alkyl group having 1 to 5 carbon atoms but is preferably similar to the embodiments of R⁵ and R⁶ in General Formula (II-3).)

In the above General Formula (II-3a) to General Formula (II-3f), R⁵ is preferably similar to the embodiment in General Formula (II-3).

In the above General Formula (II-3a) to General Formula (II-3f), R^{6a} is preferably an alkyl group having 1 to 3 carbon atoms, more preferably an alkyl group having 1 or 2 carbon atoms, and particularly preferably an alkyl group having 2 carbon atoms.

Among the above General Formula (II-3a) to General Formula (II-3f), General Formula (II-3a) or General Formula (II-3e) is preferable in order to increase an absolute value of the dielectric anisotropy, and in a composition with a large Δn, General Formula (II-3b) is preferable.

The compound represented by General Formula (II-3) in the liquid crystal composition of the present invention is contained preferably in an amount of 20 to 45% by mass, more preferably in an amount of 25 to 40% by mass, and even more preferably in an amount of 28 to 38% by mass.

The liquid crystal composition of the present invention can contain a compound represented by the following General Formula (III) as a third component.

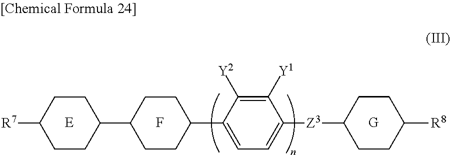

(In the formula, R⁷ and R⁸ each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; Y¹ and Y² each independently represent a hydrogen atom or a fluorine atom; E, F and G each independently represent a 1,4-phenylene group or trans-1,4-cyclohexylene; Z³ represents a single bond, —OCH₂—, —OCO—, —CH₂O—, or —COO—; and n represents 0 or 1.)

In the above General Formula (III), R⁷ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms.

When E represents trans-1,4-cyclohexylene, R⁷ preferably represents an alkyl group having 1 to 5 carbon atoms or an alkenyl group having 2 to 5 carbon atoms, more preferably represents an alkyl group having 2 to 5 carbon atoms or an alkenyl group having 2 to 4 carbon atoms, even more preferably represents an alkyl group having 3 to 5 carbon atoms or an alkenyl group having 2 carbon atoms, and particularly preferably represents an alkyl group having 3 carbon atoms.

When E represents a 1,4-phenylene group which may be substituted with fluorine, R⁷ preferably represents an alkyl group having 1 to 5 carbon atoms or an alkenyl group having 4 or 5 carbon atoms, more preferably represents an alkyl group having 2 to 5 carbon atoms or an alkenyl group having 4 carbon atoms, and even more preferably represents an alkyl group having 2 to 4 carbon atoms.

In the above General Formula (III), R⁸ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms.

When G represents trans-1,4-cyclohexylene, R⁸ preferably represents an alkyl group having 1 to 5 carbon atoms or an alkenyl group having 2 to 5 carbon atoms, more preferably represents an alkyl group having 2 to 5 carbon atoms or an alkenyl group having 2 to 4 carbon atoms, even more preferably represents an alkyl group having 3 to 5 carbon atoms or an alkenyl group having 2 carbon atoms, and particularly preferably represents an alkyl group having 3 carbon atoms.

When G represents a 1,4-phenylene group which may be substituted with fluorine, R⁸ preferably represents an alkyl group having 1 to 5 carbon atoms or an alkenyl group having 4 or 5 carbon atoms, more preferably represents an alkyl group having 2 to 5 carbon atoms or an alkenyl group having 4 carbon atoms, and even more preferably represents an alkyl group having 2 to 4 carbon atoms.

When R⁷ and R⁸ represent an alkenyl group and F or G bonded thereto represents a 1,4-phenylene group which may be substituted with fluorine in the above General Formula (III), the alkenyl group having 4 or 5 carbon atoms preferably has a structure represented by the following formula.

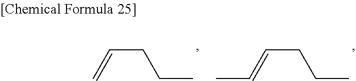

(In the formula, the end on the right-hand side is bonded to the cyclic structure.)

In this case also, an alkenyl group having 4 carbon atoms is more preferable.

In the above General Formula (III), Y¹ and Y² each independently represent a hydrogen atom or a fluorine atom. Preferably, any one of Y¹ and Y² represents a fluorine atom. If the absolute value of the dielectric anisotropy is important, both Y¹ and Y² preferably represent a fluorine atom.

In the above General Formula (III), E, F, and G each independently represent a 1,4-phenylene group, which may be substituted with fluorine, or trans-1,4-cyclohexylene, but preferably represent an unsubstituted 1,4-phenylene group or trans-1,4-cyclohexylene.

In the above General Formula (III), Z² represents a single bond, —OCH₂—, —OCO—, —CH₂O—, or —COO—, but preferably represents a single bond, —CH₂O—, or —COO— and more preferably represents a single bond.

In the above General Formula (III), n represents 0 or 1. When Z³ represents a substituent other than a single bond, n preferably represents 0.

The compound represented by the above General Formula (III) having n representing 0 is specifically preferably compounds represented by the following General Formula (III-1a) to General Formula (III-1h).

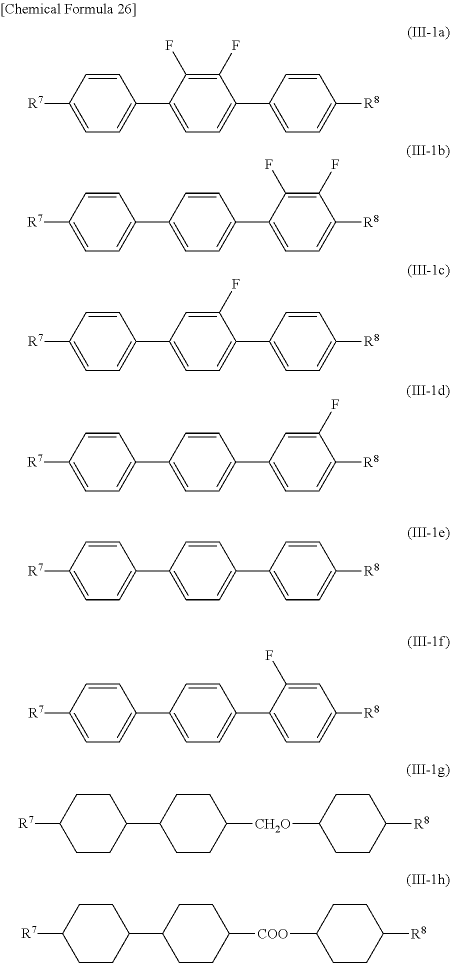

(In the formula, R⁷ and R⁸ each independently represent an alkyl group having 1 to 5 carbon atoms, an alkenyl group having 2 to 5 carbon atoms, or an alkoxy group having 1 to 5 carbon atoms, but are preferably similar to the embodiments of R⁷ and R⁸ in General Formula (III).)

The compound represented by the above General Formula (III) having n representing 1 is specifically preferably compounds represented by the following General Formula (III-2a) to General Formula (III-21).

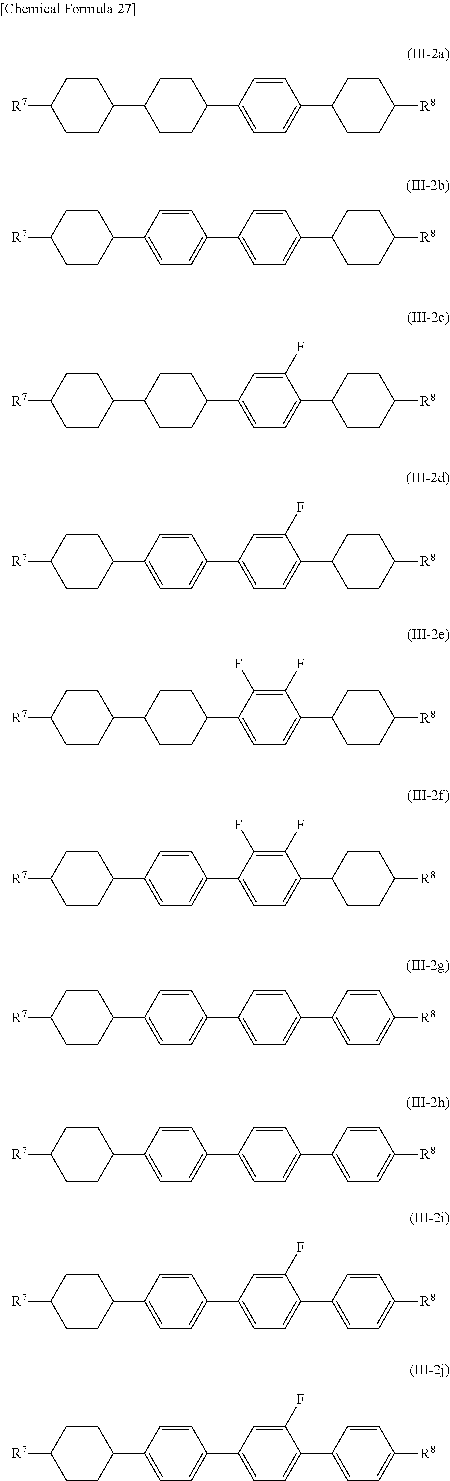

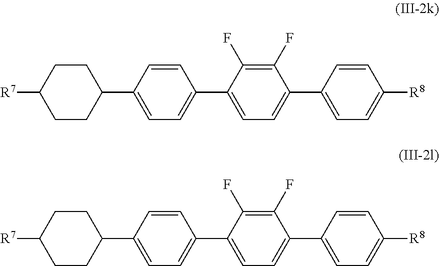

(In the formula, R⁷ and R⁸ each independently represent an alkyl group having 1 to 5 carbon atoms, an alkenyl group having 2 to 5 carbon atoms, or an alkoxy group having 1 to 5 carbon atoms, but are preferably similar to the embodiments of R⁷ and R⁸ in General Formula (III).)

The compound represented by General Formula (III) in the liquid crystal composition of the present invention is contained preferably in an amount of 5 to 20% by mass, more preferably in an amount of 8 to 15% by mass, and even more preferably in an amount of 10 to 13% by mass.

The liquid crystal composition in the present invention is constituted by a combination of compounds represented by the above General Formula (I) to General Formula (III). The contents of the respective compounds contained in the combination are preferably as follows.

The compounds represented by the above General Formula (II-1), General Formula (II-2), and General Formula (II-1′) are each a compound having a negative dielectric anisotropy with a relatively large absolute value. The total content of these compounds in the liquid crystal composition is preferably 30 to 65% by mass, more preferably 40 to 55% by mass, and particularly preferably 43 to 50% by mass.

The compound represented by the above General Formula (III) may include a compound having a positive dielectric anisotropy and a compound having a negative dielectric anisotropy. When a compound having a negative dielectric anisotropy with an absolute value of 0.3 or more is used, the total content of the compounds represented by General Formula (II-1), General Formula (II-2), General Formula (II-1′), and General Formula (III) is preferably 35 to 70% by mass, more preferably 45 to 65% by mass, and particularly preferably 50 to 60% by mass.

Further, the liquid crystal composition in the present invention preferably contains 30 to 50% by mass of a compound represented by the above General Formula (I) and 35 to 70% by mass of compounds represented by General Formula (II-1), General Formula (II-2), General Formula (II-1′), and General Formula (III).

The liquid crystal composition in the present invention more preferably contains 35 to 45% by mass of a compound represented by the above General Formula (I) and 45 to 65% by mass of compounds represented by General Formula (II-1), General Formula (II-2), General Formula (II-1′), and General Formula (III).

The liquid crystal composition in the present invention particularly preferably contains 38 to 42% by mass of a compound represented by the above General Formula (I) and 50 to 60% by mass of compounds represented by General Formula (II-1), General Formula (II-2), General Formula (II-1′), and General Formula (III).

Further, the total content of the compounds represented by General Formula (II-1), General Formula (II-2), General Formula (II-1′), and General Formula (III) is preferably 80 to 100% by mass, more preferably 90 to 100% by mass, and particularly preferably 95 to 100% by mass with respect to the entire liquid crystal composition.

The liquid crystal composition in the present invention can be used in a wide range of the nematic phase-isotropic liquid phase transition temperature (Tni), but the nematic phase-isotropic liquid phase transition temperature (Tni) is preferably 60 to 120° C., more preferably 70 to 100° C., and particularly preferably 70 to 85° C.

The dielectric anisotropy of the liquid crystal composition in the present invention is preferably −2.0 to −6.0, more preferably −2.5 to −5.0, and particularly preferably −2.5 to −3.5 at 25° C.

The refractive index anisotropy of the liquid crystal composition in the present invention is preferably 0.08 to 0.13 and more preferably 0.09 to 0.12 at 25° C. To be more specific, when the cell gap is small, the refractive index anisotropy of the liquid crystal composition in the present invention is preferably 0.10 to 0.12 at 25° C. When the cell gap is large, the refractive index an isotropy of the liquid crystal composition in the present invention is preferably 0.08 to 0.10 at 25° C.

### [Method for Producing Liquid Crystal Display Element]

Next, a method for producing a liquid crystal display element of the present invention will be described with reference to FIG. 1.

An alignment material, which contains a polymerizable compound having a reactive group and a vertical alignment material, is applied to a surface of the first substrate 11 on which the common electrode 14 is formed and a surface of the second substrate 12 on which the pixel electrode 15 is formed and heated to form the vertical alignment films 16 and 17.

Herein, first, an alignment material, which contains a polymerizable compound selected from a polymer compound precursor serving as a vertical alignment material and a compound group consisting of compounds represented by the above General Formula (VI) and General Formula (V) serving as a polymerizable compound, and as necessary, a photo-polymerizable or photo-crosslinkable compound, is prepared.

When the main constituent of the vertical alignment material is polyimide, examples of the polymer compound precursor include a polyimide solution in which a mixture of tetracarboxylic dianhydride and diisocyanate, polyamic acid, and polyimide are dissolved or dispersed in a solvent. The content of polyimide in this polyimide solution is preferably 1% by mass or more but 10% by mass or less, and more preferably 3% by mass or more but 5% by mass or less.

Further, when the main constituent of the vertical alignment material is polysiloxane, examples of the polymer compound precursor include a polysiloxane solution prepared by dissolving, in a solvent, polysiloxane synthesized by heating a mixture of a silicon compound having an alkoxy group, a silicon compound having a halogenated alkoxy group, alcohol, and oxalic acid mixed at a predetermined mixing amount ratio.

Incidentally, a photo-crosslinkable compound, a photopolymerization initiator, a solvent, or the like may be added to the vertical alignment material as necessary.

After the alignment material is prepared, this alignment material is applied to or printed on each of the first substrate 11 and the second substrate 12 so as to cover the common electrode 14, pixel electrode 15, and slit portions thereof (not illustrated in the drawing), and then subjected to treatment such as heating. According to this, the polymer compound precursor contained in the applied or printed alignment material is polymerized and cured to form a vertical alignment material, and thus the vertical alignment films 16 and 17 in which the vertical alignment material and the polymerizable compound are mixed are formed.

Herein, in a case where heat treatment is performed, the temperature is preferably 80° C. or higher and more preferably 150 to 200° C.

Incidentally, the alignment control portion that contains a vertical alignment material is formed at this stage. Thereafter, treatment such as rubbing may be conducted as necessary.

Next, the first substrate 11 and the second substrate 12 are stacked and the liquid crystal composition layer 13 containing liquid crystal molecule is sealed in a space therebetween.

Specifically, spacer projections, such as plastic beads, for securing the cell gap are scattered onto the surface of one of the first substrate 11 and the second substrate 12 on which the vertical alignment film 16 or 17 is formed and a sealing portion is printer by, for example, a screen printing method using an epoxy adhesive or the like.

Then, the first substrate 11 and the second substrate 12 are bonded to each other with the spacer projections and the sealing portion interposed therebetween such that the vertical alignment films 16 and 17 face each other, and then a liquid crystal composition containing liquid crystal molecules and a polymerizable compound is injected.

Then, the sealing portion is cured by heating or the like to seal the liquid crystal composition between the first substrate 11 and the second substrate 12.

Next, a voltage is applied between the common electrode 14 and the pixel electrode 15 by using a voltage application means. For example, a voltage of 5 to 30 (V) is applied. According to this, an electric field is generated in a direction that forms a predetermined angle with respect to the surface of the first substrate 11 adjacent to the liquid crystal composition layer 13 (the surface facing the liquid crystal composition layer 13) and the surface of the second substrate 12 adjacent to the liquid crystal composition layer 13 (the surface facing the liquid crystal composition layer 13), and thus the liquid crystal molecules 19 tilt in a predetermined direction from a normal direction of the first substrate 11 and the second substrate 12. At this time, the tilt angle of the liquid crystal molecules 19 is substantially equal to the pre-tilt θ provided to the liquid crystal molecules 19 in the step described below. Therefore, the magnitude of the pre-tilt θ of the liquid crystal molecules 19 can be controlled by appropriately adjusting the magnitude of the voltage (see FIG. 3).

Further, while a voltage is applied, ultraviolet light UV is applied, for example, from the outer side of the first substrate 11 to the liquid crystal composition layer 13 so as to polymerize the polymerizable compound in the vertical alignment films 16 and 17 and the polymerizable compound in the liquid crystal composition, thereby forming a high-molecular-weight polymer. In this case, the intensity of the ultraviolet light UV applied may be constant or varied. When the intensity of irradiation is to be varied, the irradiation time at the respective intensity may be arbitrary. In a case where irradiation is conducted in two or more stages, it is preferable to select the irradiation intensity of the second stage and subsequent stage smaller than the irradiation intensity of the first stage. The total irradiation time of the second stage and subsequent stage is preferably longer than the irradiation time of the first stage, and the total irradiation energy quantity of the second stage and subsequent stage is preferably larger than that of the first stage. In addition, in a case where the irradiation intensity is to be discontinuously varied, the average irradiation intensity in the first half of the entire irradiation time is preferably larger than the average irradiation intensity in the second half. More preferably, the intensity immediately after start of irradiation is the highest. Even more preferably, the irradiation intensity keeps decreasing to a certain value with the passage of the irradiation time. The ultraviolet light UV intensity in this case is preferably 2 mW/cm⁻² to 100 mW/cm⁻². More preferably, the highest irradiation intensity in the first stage of multi-stage irradiation or in all irradiation stages in which the irradiation intensity is discontinuously varied is 10 mW/cm⁻² to 100 mW/cm⁻², and the lowest irradiation intensity in the second stage and subsequent stage of multi-stage irradiation or in discontinuously varying the irradiation intensity is 2 mW/cm⁻² to 50 mW/cm⁻². Further, the total irradiation energy quantity is preferably 10 J to 300 J, more preferably 50 J to 250 J, and even more preferably 100 J to 250 J.

In this case, the applied voltage may be AC or DC.

As a result, alignment regulating portions (not illustrated in the drawing) fixed to the alignment control portions of the vertical alignment films 16 and 17 and containing a vertical alignment material are formed, and further, the polymer layers 20 and 21 are formed on the surfaces thereof. These alignment regulating portions have function of providing a pre-tilt θ to the liquid crystal molecules 19 located in the vicinity of the interfaces between the liquid crystal composition layer 13 and the polymer layer 20 (vertical alignment film 16) and between the liquid crystal composition layer 13 and the polymer layer 21 (vertical alignment film 17) in a non-operating state. Incidentally, herein, ultraviolet light UV is applied from the outer side of the first substrate 11, but may be applied from the outer side of the second substrate 12 or from both the outer side of the first substrate 11 and the outer side of the second substrate 12.

As described above, in the liquid crystal display element of the present invention, the liquid crystal molecules 19 in the liquid crystal composition layer 13 have a predetermined pre-tilt θ. Thus, as compared to a liquid crystal display element not subjected to pre-tilt treatment and a liquid crystal display device provided with such a liquid crystal display element, the response speed with respect to a drive voltage can be significantly improved.

In the liquid crystal display element of the present invention, the polymer compound precursor constituting the vertical alignment films 16 and 17 is preferably a polyimide precursor that is not sensitive to light.

The total content of the polymerizable compound in the polymer compound precursor in the vertical alignment films 16 and 17 is preferably 0.5 to 4% by mass and more preferably 1 to 2% by mass.

The total content of the polymerizable compound forming the polymer layers 20 and 21 in the liquid crystal composition is preferably 0.1 to 1% by mass and more preferably 0.2 to 0.6% by mass.

### EXAMPLES

Hereinafter, the present invention will be described in more detail by means by Examples and Comparative Examples. However, the present invention is not limited to Examples described below. For compositions of Examples and Comparative Examples described below, “%” means “% by mass.”

In Examples and Comparative Examples described below, Tni, Δn, Δ∈, η, and γ₁ are defined as follows.

Tₙᵢ: Nematic phase-isotropic liquid phase transition temperature (° C.)

Δn: Refractive index anisotropy at 25° C.

Δ∈: Dielectric anisotropy at 25° C.

η: Viscosity at 20° C. (mPa·s)

γ₁: Rotational viscosity at 25° C. (mPa·s)

In Examples and Comparative Examples described below, ghosting and drop marks of liquid crystal display elements were evaluated by the following methods.

### (Ghosting)

Regarding evaluation of ghosting of the liquid crystal display elements, a predetermined fixed pattern was displayed in a display area for 1000 hours, and then the level of a residual image of the fixed pattern when an image is evenly displayed in all parts of the screen was observed with naked eye and evaluated on the basis of the following four-level criteria.

⊙: No residual image was observed.
◯: A residual image was slightly observed but was at an acceptable level.
Δ: A residual image was observed and was at an unacceptable level.
X: A residual image was observed and was at a very poor level.

### (Drop Marks)

Regarding evaluation of drop marks of liquid crystal display devices, drop marks that appeared as white marks when black was displayed in all parts of the screen were observed with naked eye and evaluated on the basis of the following four-level criteria.

⊙: No residual image was observed.
◯: A residual image was slightly observed but was at an acceptable level.
Δ: A residual image was observed and was at an unacceptable level.
X: A residual image was observed and was at a very poor level.

Incidentally, in Examples, the following abbreviations were used in describing compounds.

### (Side Chain)

n represents —CₙH₂ₙ₊₁ (linear alkyl group having n carbon atoms).
On represents —OCₙH₂ₙ₊₁ (linear alkoxy group having n carbon atoms).

### (Cyclic Structure)

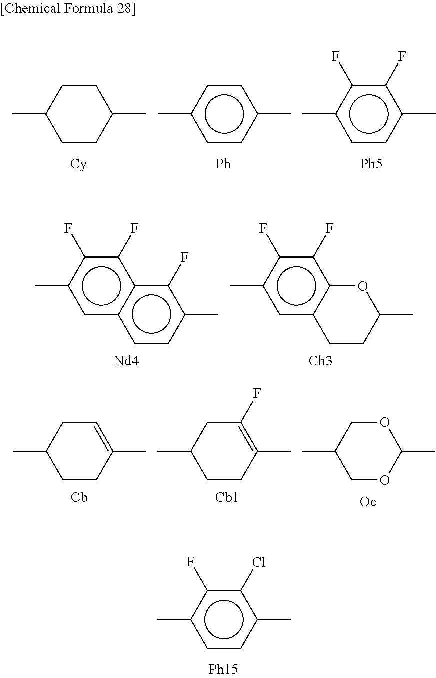

### Example 1

A first substrate (common electrode substrate) that includes a transparent electrode layer formed by a transparent common electrode and a color filter layer and a second substrate (pixel electrode substrate) that includes a pixel electrode layer having transparent pixel electrodes driven by active elements were prepared.

As each pixel electrode in the pixel electrode substrate, those formed by etching ITO such that slits having no electrodes were formed in the pixel electrodes to align the liquid crystal molecules in different directions.

A vertical alignment film material that contains a polyimide precursor and a polymerizable compound having a reactive group was applied to each of the common electrode substrate and the pixel electrode substrate by a spin coating method. The coating film was heated at 200° C. to cure the polyimide precursor in the vertical alignment film material, thereby forming a 100 nm vertical alignment film on a surface of each substrate. At this stage, the polymerizable compound having a reactive group in the vertical alignment film was not cured.

A solution prepared by containing 2% of a polymerizable compound having a reactive group represented by the following Formula (V-2) and 1% of a polymerizable compound having a reactive group represented by the following Formula (VI-1) in a polyimide solution (trade name: JALS2131-R6, produced by JSR Corporation) containing 3% of a polyimide precursor was used as a vertical alignment film forming material.

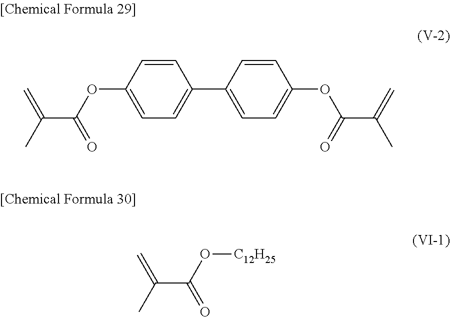

With respect to 99.7% of a liquid crystal composition containing a compound represented by a chemical formula described below,

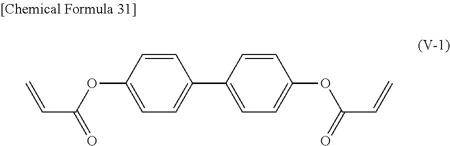 [SMILES: C=CC(=O)Oc1ccc(-c2ccc(OC(=O)C=C)cc2)cc1]

0.3% of a polymerizable compound represented by General Formula (V-1) was added to thereby prepare a polymerizable compound-containing liquid crystal composition.

The polymerizable compound-containing liquid crystal composition was interposed between the common electrode substrate and the pixel electrode substrate each having a vertical alignment film formed thereon, and then a sealing material was cured to forma liquid crystal composition layer. At this time, a spacer having a thickness of 4 μm was used to adjust the thickness of the liquid crystal composition layer to 4 μm.

Incidentally, in the liquid crystal composition, compounds belonging to group (I) in a chemical formula described below are compounds represented by the above General Formula (I) and compounds belonging to group (II) in a chemical formula described below are compounds represented by the above General Formula (II).

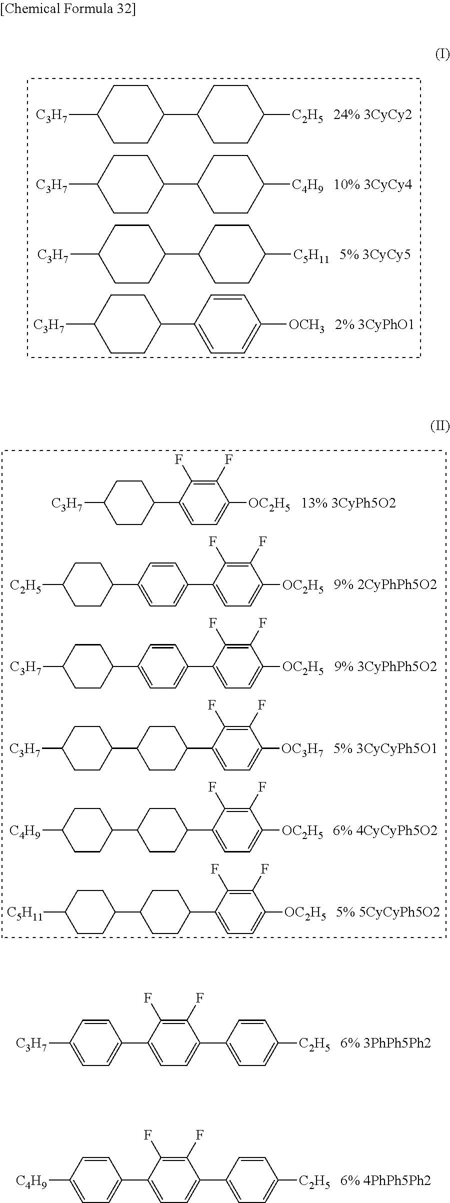

The obtained liquid crystal display element was irradiated with an ultraviolet ray while applying a square AC electric field to cure the polymerizable compound having a reactive group and the polymerizable compound in the liquid crystal composition. UIS-S2511RZ manufactured by USHIO INC. and USH-250BY manufactured by USHIO INC. as an ultraviolet lamp were used as an irradiation device, and the liquid crystal display element was irradiated with an ultraviolet ray at 20 mW for 10 minutes to thereby obtain a liquid crystal display element of Example 1. As a result of this step, a vertical alignment film that contains a polymer of the polymerizable compound having a reactive group was formed and the liquid crystal molecules in the liquid crystal composition layer were provided with a pre-tilt angle.

Herein, the pre-tilt angle is defined as illustrated in FIG. 3. In a case where the molecules are aligned perfectly vertically, the pre-tilt angle (θ) is 90°, and in a case where a pre-tilt angle is provided, the pre-tilt angle (θ) is smaller than 90°.

The liquid crystal display element of Example 1 had pre-tilt angles in four different directions in four domains, respectively, formed along the slits of the pixel electrode as illustrated in FIG. 2, and the pre-tilt angles were retained after curing of the polymerizable compound even when the AC electric field was turned off. The retained pre-tilt angle was 87.5°.

It was found that the liquid crystal display element of Example 1 obtained in this way exhibited an excellent response speed, suppressed drop marks, and was excellent in ghosting resistance as illustrated in Table 1.

TABLE 1

| | |
|---|---|
| T_{NI}/° C. | 81.0 |
| Δn | 0.103 |
| nₒ | 1.483 |
| ε_{/ /} | 3.3 |
| ε_{⊥} | 6.2 |
| Δ_{ε} | −2.9 |
| η/mPa · s | 20.3 |
| γ₁/mPa · s | 112 |
| γ₁/Δn² × 10⁻² | 104 |
| Drop mark evaluation | ⊚ |
| Ghosting evaluation | ⊚ |
| Response speed/ms | 80 |

### Comparative Example 1

A vertical alignment film was formed on each of the common electrode substrate and the pixel electrode substrate by using a polyimide solution (trade name: JALS2131-R6, produced by JSR Corporation) containing 6% of a polyimide precursor. The polymerizable compound-containing liquid crystal composition used in Example 1 was interposed between the common electrode substrate and the pixel electrode substrate, and then a sealing material was cured to thereby form a liquid crystal composition layer. At this time, a spacer having a thickness of 4 μm was used to adjust the thickness of the liquid crystal composition layer to 4 μm.

Under the same conditions as in Example 1, irradiation with an ultraviolet ray was performed while applying a square AC electric field to cure the polymerizable compound in the liquid crystal composition, thereby obtaining a liquid crystal display element of Comparative Example 1.

The liquid crystal display element of Comparative Example 1 had pre-tilt angles, and the pre-tilt angles were retained after curing of the polymerizable compound even when the AC electric field was turned off. The retained pre-tilt angle was 87°.

The liquid crystal display element of Comparative Example 1 had the same level of the response speed as compared with the liquid crystal display element of Example 1, but was inferior to evaluations on drop marks and ghosting.

TABLE 2

| Drop mark evaluation | X |
|---|---|
| Ghosting evaluation | Δ |
| Response speed/ms | 8.2 |

### Comparative Example 2

A liquid crystal composition containing a compound represented by a chemical formula described below was prepared, and the same amount of a polymerizable compound as that in Example 1 was added to the liquid crystal composition to thereby prepare a polymerizable compound-containing liquid crystal composition. A liquid crystal display element of Comparative Example 2 was obtained in the same manner as in Example 1, except that a liquid crystal compound in the liquid crystal composition was used.

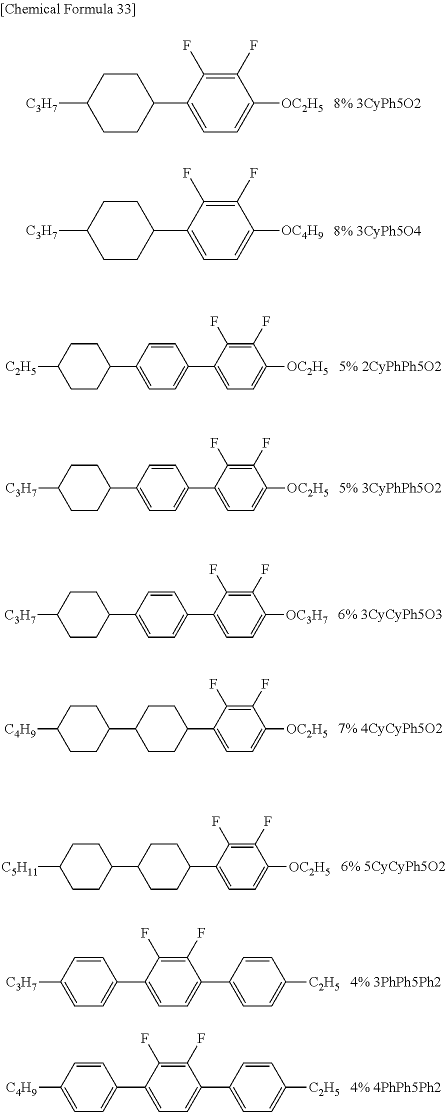

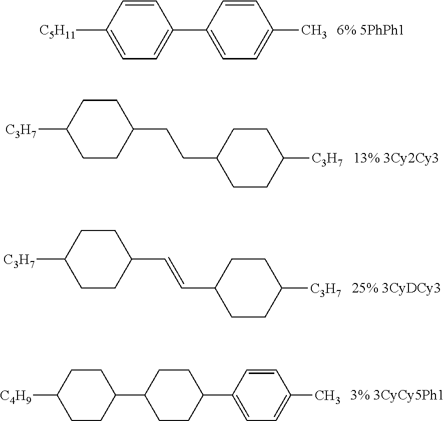

Ghosting and drop marks of the liquid crystal display element of Comparative Example 2 were measured in the same manner as in Example 1. The results thereof are presented in the following table.

As a result, the liquid crystal composition prepared in Comparative Example 2 exhibited poor results as compared with the liquid crystal composition prepared in Example 1. In addition, the liquid crystal composition prepared in Comparative Example 2 exhibited an inferior response speed to the liquid crystal composition prepared in Example 1.

TABLE 3

| | |
|---|---|
| T_{NI}/° C. | 80.2 |
| Δn | 0.104 |
| nₒ | 1.481 |
| ε_{//} | 3.1 |
| ε_{⊥} | 6.0 |
| Δ_{ε} | −3.0 |
| η/mPa · s | 19.6 |
| γ₁/mPa · s | 143 |
| γ₁/Δn² × 10⁻² | 131 |
| Drop mark evaluation | Δ |
| Ghosting evaluation | X |
| Response speed/ms | 10.9 |

### Comparative Example 3

A liquid crystal composition composed of the composition in the table described below was prepared, and the same polymerizable compound as in Example 1 was added to the liquid crystal composition to thereby prepare a polymerizable compound-containing liquid crystal composition. A liquid crystal display element of Comparative Example 3 was obtained in the same manner as in Example 1, except that a liquid crystal compound in the liquid crystal composition was used.

TABLE 4

| | |
|---|---|
| T_{NI}/° C. | 80.5 |
| Δn | 0.103 |
| nₒ | 1.479 |
| ε_{//} | 3.1 |
| ε_{⊥} | 6.2 |
| Δ_{ε} | −3.0 |
| η/mPa · s | 18.5 |
| γ₁/mPa · s | 132 |
| γ₁/Δn² × 10⁻² | 125 |
| 3CyPh5O2 | 9% |
| 3CyPh5O4 | 9% |
| 2CyPhPh5O2 | 4% |
| 3CyPhPh5O2 | 4% |
| 3CyCyPh5O3 | 7% |
| 4CyCyPh5O2 | 7% |
| 5CyCyPh5O2 | 7% |
| 3PhPh5Ph2 | 3% |
| 4PhPh5Ph2 | 3% |
| 5PhPh1 | 3% |
| 3Cy2Cy3 | 15% |
| 3CyDCy3 | 25% |
| 0d3PhTPh3d0 | 2% |
| 3CyPhTPh2 | 2% |
| Drop mark evaluation | X |
| Ghosting evaluation | Δ |
| Response speed/ms | 10.2 |

Ghosting and drop marks of the liquid crystal display element of Comparative Example 3 were measured in the same manner as in Example 1. The results thereof are presented in the table.

As a result, the liquid crystal composition prepared in Comparative Example 3 exhibited poor results as compared with the liquid crystal composition prepared in Example 1. In addition, the liquid crystal composition prepared in Comparative Example 3 exhibited an inferior response speed to the liquid crystal composition prepared in Example 1.

### Example 2

A common electrode substrate and a pixel electrode substrate each having a vertical alignment film formed thereon were obtained in the same manner as in Example 1, except that a solution prepared by containing 2% of a polymerizable compound having a reactive group represented by Formula (V-2) and 1% of a polymerizable compound having a reactive group represented by the following Formula (VI-2) in a polyimide solution (trade name: JALS2131-R6, produced by JSR Corporation) containing 3% of a polyimide precursor was used as a vertical alignment film forming material.

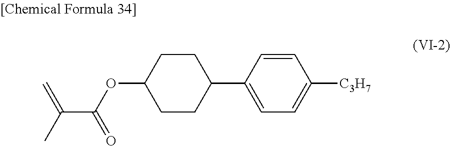

A liquid crystal display element of Example 2 was obtained in the same manner as in Example 1 by preparing a polymerizable compound-containing liquid crystal composition obtained by adding 0.3% of a polymerizable compound represented by General Formula (V-2) with respect to 99.7% of the liquid crystal composition used in Example 1, and interposing the polymerizable compound-containing liquid crystal composition between the common electrode substrate and the pixel electrode substrate each having a vertical alignment film formed thereon.

Ghosting and drop marks of the liquid crystal display element of Example 2 were measured in the same manner as in Example 1. The results thereof are presented in the following table.

As a result, it was found that the liquid crystal display element of Example 2 was slightly inferior to the liquid crystal display element of Example 1 but exhibited an excellent response speed, suppressed drop marks, and was excellent in ghosting resistance.

TABLE 5

| Drop mark evaluation | ◯ |
|---|---|
| Ghosting evaluation | ◯ |
| Response speed/ms | 8.2 |

### Example 3

A common electrode substrate and a pixel electrode substrate each having a vertical alignment film formed thereon were obtained in the same manner as in Example 1, except that a solution prepared by containing 2% of a polymerizable compound having a reactive group represented by the following Formula (V-4a) and 1% of a polymerizable compound having a reactive group represented by Formula (VI-1) in a polyimide solution (trade name: JALS2131-R6, produced by JSR Corporation) containing 3% of a polyimide precursor was used as a vertical alignment film forming material.

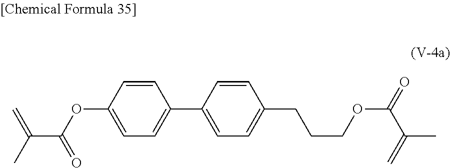 [SMILES: C=C(C)C(=O)OCCCc1ccc(-c2ccc(OC(=O)C(=C)C)cc2)cc1]

A liquid crystal display element of Example 3 was obtained in the same manner as in Example 1 by preparing a polymerizable compound-containing liquid crystal composition obtained by adding 0.3% of a polymerizable compound represented by General Formula (V-2) with respect to 99.7% of the liquid crystal composition used in Example 1, and interposing the polymerizable compound-containing liquid crystal composition between the common electrode substrate and the pixel electrode substrate each having a vertical alignment film formed thereon.

Ghosting and drop marks of the liquid crystal display element of Example 3 were measured in the same manner as in Example 1. The results thereof are presented in the following table.

As a result, it was found that the liquid crystal display element of Example 3 was slightly inferior to the liquid crystal display element of Example 1 but exhibited an excellent response speed, suppressed drop marks, and was excellent in ghosting resistance.

TABLE 6

| Drop mark evaluation | ◯ |
|---|---|
| Ghosting evaluation | ◯ |
| Response speed/ms | 8.3 |

### Example 4

A common electrode substrate and a pixel electrode substrate each having a vertical alignment film formed thereon were obtained in the same manner as in Example 1, except that a solution prepared by containing 2% of a polymerizable compound having a reactive group represented by the following Formula (V-5) and 1% of a polymerizable compound having a reactive group represented by Formula (VI-2) in a polyimide solution (trade name: JALS2131-R6, produced by JSR Corporation) containing 3% of a polyimide precursor was used as a vertical alignment film forming material.

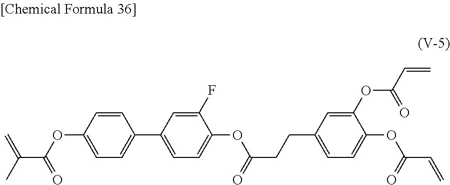 [SMILES: C=CC(=O)Oc1ccc(CCC(=O)Oc2ccc(-c3ccc(OC(=O)C(=C)C)cc3)cc2F)cc1OC(=O)C=C]

A liquid crystal display element of Example 4 was obtained in the same manner as in Example 1 by preparing a polymerizable compound-containing liquid crystal composition obtained by adding 0.3% of a polymerizable compound represented by General Formula (V-2) with respect to 99.7% of the liquid crystal composition used in Example 1, and interposing the polymerizable compound-containing liquid crystal composition between the common electrode substrate and the pixel electrode substrate each having a vertical alignment film formed thereon.

Ghosting and drop marks of the liquid crystal display element of Example 4 were measured in the same manner as in Example 1. The results thereof are presented in the following table.

As a result, it was found that the liquid crystal display element of Example 4 was slightly inferior to the liquid crystal display element of Example 1 but exhibited an excellent response speed, suppressed drop marks, and was excellent in ghosting resistance.

TABLE 7

| Drop mark evaluation | ◯ |
|---|---|
| Ghosting evaluation | ◯ |
| Response speed/ms | 8.3 |

### Example 5

A liquid crystal display element of Example 5 was obtained in the same manner as in Example 1, except that a liquid crystal composition composed of the composition described below was prepared and this liquid crystal composition was used.

TABLE 8

| | |
|---|---|
| T_{NI}/° C. | 80.2 |
| Δn | 0.105 |
| nₒ | 1.485 |
| ε_{//} | 3.2 |
| ε_{⊥} | 6.1 |
| Δ_{ε} | −2.9 |
| η/mPa · s | 22.7 |
| γ₁/mPa · s | 124 |
| γ₁/Δn² × 10⁻² | 112 |
| 3CyCy2 | 20% |
| 3CyCy4 | 10% |
| 3CyPh5O2 | 7% |
| 3CyPh5O4 | 7% |
| 2CyPhPh5O2 | 6% |
| 3CyPhPh5O2 | 7% |
| 3CyCyPh5O3 | 7% |
| 4CyCyPh5O2 | 8% |
| 5CyCyPh5O2 | 7% |
| 3PhPh5Ph2 | 4% |
| 4PhPh5Ph2 | 4% |
| 5PhPh1 | 8% |
| 3CyCyPh1 | 5% |
| Drop mark evaluation | ◯ |
| Ghosting evaluation | ◯ |
| Response speed/ms | 9.2 |

Ghosting and drop marks of the liquid crystal display element of Example 5 were measured in the same manner as in Example 1. The results thereof are presented in the above table.

As a result, it was found that the liquid crystal display element of Example 5 was slightly inferior to the liquid crystal display element of Example 1 but exhibited a relatively excellent response speed, suppressed drop marks, and was excellent in ghosting resistance.

### Example 6

A liquid crystal display element of Example 6 was obtained in the same manner as in Example 1, except that a liquid crystal composition composed of the composition described below was prepared and this liquid crystal composition was used.

TABLE 9

| | |
|---|---|
| T_{NI}/° C. | 80.3 |
| Δn | 0.106 |
| nₒ | 1.486 |
| ε_{//} | 3.3 |
| ε_{⊥} | 6.2 |
| Δ_{ε} | −2.9 |
| η/mPa · s | 21.4 |
| γ₁/mPa · s | 121 |
| γ₁/Δn² × 10⁻² | 107 |
| 3CyCy2 | 23% |
| 3CyCy4 | 5% |
| 3CyPhO1 | 7% |
| 2CyPh5O2 | 8% |
| 3CyPh5O4 | 7% |
| 2CyPhPh5O2 | 7% |
| 3CyPhPh5O2 | 9% |
| 3CyCyPh5O3 | 5% |
| 4CyCyPh5O2 | 6% |
| 5CyCyPh5O2 | 5% |
| 3PhPh5Ph2 | 5% |
| 4PhPh5Ph2 | 6% |
| 3CyCyPh1 | 7% |
| Drop mark evaluation | ◯ |
| Ghosting evaluation | ◯ |
| Response speed/ms | 8.5 |

Ghosting and drop marks of the liquid crystal display element of Example 6 were measured in the same manner as in Example 1.

The results thereof are presented in the above table.

As a result, it was found that the liquid crystal display element of Example 6 was slightly inferior to the liquid crystal display element of Example 1 but exhibited a relatively excellent response speed, suppressed drop marks, and was excellent in ghosting resistance.

### Example 7

A liquid crystal display element of Example 7 was obtained in the same manner as in Example 1, except that a liquid crystal composition composed of the composition presented in the following table was prepared and this liquid crystal composition was used.

TABLE 10

| | |
|---|---|
| T_{NI}/° C. | 81.3 |
| Δn | 0.106 |
| nₒ | 1.483 |
| ε_{//} | 3.2 |
| ε_{⊥} | 6.0 |
| Δ_{ε} | −2.8 |
| η/mPa · s | 20.7 |
| γ₁/mPa · s | 117 |
| γ₁/Δn² × 10⁻² | 105 |
| 3CyCy2 | 21% |
| 3CyCy4 | 12% |
| 3CyCy5 | 5% |
| 2CyPh5O2 | 7% |
| 3CyPh5O4 | 8% |
| 2CyPhPh5O2 | 7% |
| 3CyPhPh5O2 | 7% |
| 3CyCyPh5O3 | 5% |
| 4CyCyPh5O2 | 5% |
| 5CyCYPh5O2 | 5% |
| 3PhPh5Ph2 | 7% |
| 4PhPh5Ph2 | 8% |
| 3CyCyPh1 | 3% |
| Drop mark evaluation | ◯ |
| Ghosting evaluation | ◯ |
| Response speed/ms | 8.1 |

Ghosting and drop marks of the liquid crystal display element of Example 7 were measured in the same manner as in Example 1. The results thereof are presented in the above table.

As a result, it was found that the liquid crystal display element of Example 7 was slightly inferior to the liquid crystal display element of Example 1 but exhibited a relatively excellent response speed, suppressed drop marks, and was excellent in ghosting resistance.

### Example 8

A liquid crystal display element of Example 8 was obtained in the same manner as in Example 1, except that a liquid crystal composition composed of the composition presented in the following table was prepared and this liquid crystal composition was used.

TABLE 11

| | |
|---|---|
| T_{NI}/° C. | 82.7 |
| Δn | 0.107 |
| nₒ | 1.486 |
| ε_{//} | 3.3 |
| ε_{⊥} | 6.3 |
| Δ_{ε} | −3.0 |
| η/mPa · s | 24.2 |
| γ₁/mPa · s | 141 |
| γ₁/Δn² × 10⁻² | 123 |
| 3CyCy2 | 24% |
| 3CyCy4 | 5% |
| 3CyPhO1 | 6% |
| 2CyPh5O2 | 5% |
| 3CyPh5O4 | 5% |
| 2CyPhPh5O2 | 7% |
| 3CyPhPh5O2 | 9% |
| 3CyCyPh5O3 | 8% |
| 4CyCyPh5O2 | 9% |
| 5CyCyPh5O2 | 8% |
| 3PhPh5Ph2 | 5% |
| 4PhPh5Ph2 | 5% |
| 5PhPh1 | 4% |
| Drop mark evaluation | ◯ |
| Ghosting evaluation | ◯ |
| Response speed/ms | 8.1 |

Ghosting and drop marks of the liquid crystal display element of Example 8 were measured in the same manner as in Example 1. The results are presented in the above table.

As a result, it was found that the liquid crystal display element of Example 8 was slightly inferior to the liquid crystal display element of Example 1 but exhibited a relatively excellent response speed, suppressed drop marks, and was excellent in ghosting resistance.

### Example 9

A liquid crystal display element of Example 9 was obtained in the same manner as in Example 1, except that a liquid crystal composition composed of the composition described below was prepared and this liquid crystal composition was used.

TABLE 12

| | |
|---|---|
| T_{NI}/° C. | 82.4 |
| Δn | 0.103 |
| nₒ | 1.483 |
| ε_{//} | 3.4 |
| ε_{⊥} | 6.1 |
| Δ_{ε} | −2.8 |
| η/mPa · s | 19.3 |
| γ₁/mPa · s | 143 |
| γ₁/Δn² × 10⁻² | 135 |
| 3CyCy2 | 24% |
| 3CyCy4 | 10% |
| 3CyCy5 | 7% |
| 3CyPhO1 | 2% |
| 3PhPh5O2 | 5% |
| 3CyPh5O2 | 8% |
| 2CyPhPh5O2 | 8% |
| 3CyPhPh5O2 | 9% |
| 3CyCyPh5O3 | 5% |
| 4CyCyPh5O2 | 6% |
| 5CyCyPh5O2 | 6% |
| 3PhPh5Ph2 | 5% |
| 4PhPh5Ph2 | 5% |
| Drop mark evaluation | ⊙ |
| Ghosting evaluation | ⊙ |
| Response speed/ms | 7.9 |

Ghosting and drop marks of the liquid crystal display element of Example 9 were measured in the same manner as in Example 1. The results thereof are presented in the above table.

As a result, it was found that the liquid crystal display element of Example 9 exhibited the same level of excellent response speed as the liquid crystal display element of Example 1, suppressed drop marks, and was excellent in ghosting resistance.

### REFERENCE SIGNS LIST

10: Liquid Crystal Display Element
11: First Substrate
12: Second Substrate
13: Liquid Crystal Composition Layer
14: Common Electrode
15: Pixel Electrode
16: Vertical Alignment Film
17: Vertical Alignment Film
18: Color Filter
19: Liquid Crystal Molecule
20: Polymer Layer
21: Polymer Layer

1. A liquid crystal display element comprising:
a first substrate having a common electrode;
a second substrate having a pixel electrode; and
a liquid crystal composition layer interposed between the first substrate and the second substrate,
the liquid crystal display element controlling liquid crystal molecules in the liquid crystal composition layer by applying an electrical charge between the common electrode and the pixel electrode substantially vertically to the first substrate and the second substrate, wherein
a vertical alignment film that controls an alignment direction of the liquid crystal molecules in the liquid crystal composition layer substantially vertical to surfaces of the first substrate and the second substrate that are adjacent to the liquid crystal composition layer is provided on at least one of the first substrate and the second substrate,
the vertical alignment film contains a polymerizable compound having a reactive group or a polymer of a mixed product thereof, and
a polymer of one or two or more kinds of polymerizable compound which controls the alignment of the liquid crystal molecules to stabilize the alignment is formed on the surface of the vertical alignment film.

2. The liquid crystal display element according to claim 1, wherein the liquid crystal composition constituting the liquid crystal composition layer contains a compound represented by the following General Formula (I): 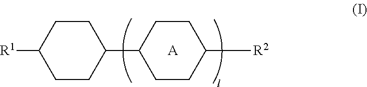
(in the formula, R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; A represents a 1,4-phenylene group or a trans-1,4-cyclohexylene group; 1 represents 1 or 2; and when 1 is 2, two A may be the same as or different from each other), and
a compound represented by the following General Formula (II): 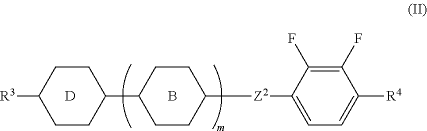
(in the formula, R³ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; R⁴ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms; B and D each independently represent a 1,4-phenylene group or a trans-1,4-cyclohexylene group; Z² represents a single bond, —OCH₂—, —OCO—, —CH₂O—, or —COO—; m represents 0, 1, or 2; and when m is 2, two B may be the same as or different from each other).

3. The liquid crystal display element according to claim 1, wherein the polymerizable compound constituting the polymer formed on the surface of the vertical alignment film is a polymerizable compound represented by the following General Formula (V): 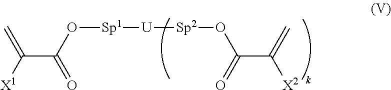
(in the formula, X¹ and X² each independently represent a hydrogen atom or a methyl group; Sp¹ and Sp² each independently represent a single bond, an alkylene group having 1 to 8 carbon atoms, or —O—(CH₂)ₛ— (in the formula, s represents an integer of 2 to 7 and the oxygen atom is to bond with an aromatic ring); U represents a linear or branched polyvalent alkylene group having 2 to 20 carbon atoms or a polyvalent cyclic substituent having 5 to 30 carbon atoms; an alkylene group in the polyvalent alkylene group may be substituted with an oxygen atom as long as the oxygen atoms are not adjacent to each other or may be substituted with an alkyl group having 5 to 20 carbon atoms (an alkylene group in the group may be substituted with an oxygen atom as long as the oxygen atoms are not adjacent to each other) or a cyclic substituent; and k represents an integer of 1 to 5).

4. The liquid crystal display element according to claim 1, comprising a plurality of pixels each including two or more domains with pre-tilt angles different from one another.

5. The liquid crystal display element according to claim 1, wherein the vertical alignment film contains a polyimide structure.

6. The liquid crystal display element according to claim 1, wherein the vertical alignment film is provided on surfaces of the first substrate and the second substrate, the surfaces being adjacent to the liquid crystal composition layer, and the first substrate includes a color filter layer.

7. The liquid crystal display element according to claim 1, wherein the polymerizable compound constituting the polymer contained in the vertical alignment film is a mixed product of a monofunctional polymerizable compound having a reactive group and a polyfunctional polymerizable compound having a reactive group.

8. The liquid crystal display element according to claim 7, wherein the polymerizable compound having a reactive group contained in the vertical alignment film is a polymerizable compound represented by the following General Formula (VI): 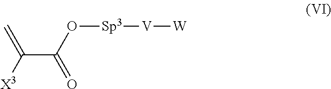
(in the formula, X³ represents a hydrogen atom or a methyl group; Sp′ represents a single bond, an alkylene group having 1 to 8 carbon atoms, or —O—(CH₂)ₜ— (in the formula, t represents an integer of 2 to 7 and the oxygen atom is to bond with an aromatic ring); V represents a linear or branched polyvalent alkylene group having 2 to 20 carbon atoms or a polyvalent cyclic substituent having 5 to 30 carbon atoms; an alkylene group in the polyvalent alkylene group may be substituted with an oxygen atom as long as the oxygen atoms are not adjacent to each other or may be substituted with an alkyl group having 5 to 20 carbon atoms (an alkylene group in the group may be substituted with an oxygen atom as long as the oxygen atoms are not adjacent to each other) or a cyclic substituent; and W represents a hydrogen atom, a halogen atom, or an alkylene group having 1 to 8 carbon atoms), and
the polyfunctional polymerizable compound having a reactive group is a polymerizable compound represented by the following General Formula (V): 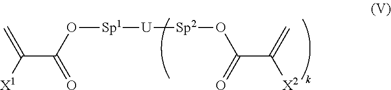
(in the formula, X¹ and X² each independently represent a hydrogen atom or a methyl group; Sp¹ and Sp² each independently represent a single bond, an alkylene group having 1 to 8 carbon atoms, or —O—(CH₂)ₛ— (in the formula, s represents an integer of 2 to 7 and the oxygen atom is to bond with an aromatic ring); U represents a linear or branched polyvalent alkylene group having 2 to 20 carbon atoms or a polyvalent cyclic substituent having 5 to 30 carbon atoms; an alkylene group in the polyvalent alkylene group may be substituted with an oxygen atom as long as the oxygen atoms are not adjacent to each other or may be substituted with an alkyl group having 5 to 20 carbon atoms (an alkylene group in the group may be substituted with an oxygen atom as long as the oxygen atoms are not adjacent to each other) or a cyclic substituent; and k represents an integer of 1 to 5).

9. The liquid crystal display element according to claim 1, wherein the pixel electrode has comb-tooth slits that extend in four directions from the center of the pixel so as to form four domains in which the liquid crystal molecules in the liquid crystal composition layer align in different directions.

10. The liquid crystal display element according to claim 1, wherein the liquid crystal composition layer is formed by a dropping method.

11. The liquid crystal display element according to claim 2, wherein the liquid crystal composition contains 30 to 60% by mass of the compound represented by the General Formula (I) and 30 to 65% by mass of the compound represented by the General Formula (II).

12. The liquid crystal display element according to claim 2, wherein the liquid crystal composition contains 5 to 20% by mass of a compound represented by the following General Formula (III): 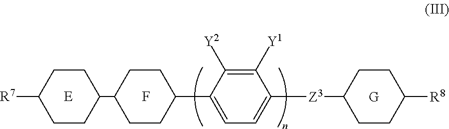
(in the formula, R⁷ and R⁸ each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; Y¹ and Y² each independently represent a hydrogen atom or a fluorine atom; E, F, and G each independently represent a 1,4-phenylene group or trans-1,4-cyclohexylene; Z³ represents a single bond, —OCH₂—, —OCO—, —CH₂O—, or —COO—; and n represents 0 or 1).

13. A method for producing a liquid crystal display element, the method comprising:
applying an alignment material to at least one of a first substrate having a common electrode and a second substrate having a pixel electrode, the alignment material containing a polymerizable compound having a reactive group and a vertical alignment material;
heating the applied alignment material to form an alignment film;
interposing a liquid crystal composition containing a polymerizable compound between the first substrate and the second substrate; and
irradiating the alignment film with an active energy ray while applying a voltage between the common electrode and the pixel electrode to polymerize the polymerizable compound in the alignment film and the polymerizable compound in the liquid crystal composition.

14. The method for producing a liquid crystal display element according to claim 13, wherein a liquid crystal composition constituting the liquid crystal composition layer contains a compound represented by the following General Formula (I): 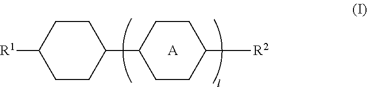
(in the formula, R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; A represents a 1,4-phenylene group or a trans-1,4-cyclohexylene group; 1 represents 1 or 2; and when 1 is 2, two A may be the same as or different from each other), and
a compound represented by the following General Formula (II): 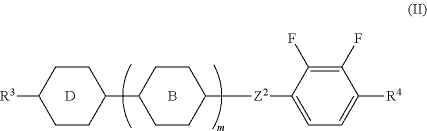
(in the formula, R³ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; R⁴ represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms; B and D each independently represent a 1,4-phenylene group or a trans-1,4-cyclohexylene group; Z² represents a single bond, —OCH₂—, —OCO—, —CH₂O—, or —COO—; m represents 0, 1, or 2; and when m is 2, two B may be the same as or different from each other).

15. The method for producing a liquid crystal display element according claim 13, wherein the active energy ray is an ultraviolet ray, an intensity thereof is 2 mW/cm⁻² to 100 mW/cm⁻², and a total irradiation energy quantity is 10 J to 300 J.

16. The method for producing a liquid crystal display element according to claim 13, wherein the liquid crystal composition contains 30 to 50% by mass of the compound represented by the General Formula (I) and 30 to 50% by mass of the compound represented by the General Formula (II).
